(19) United States
(12) Patent Application Publication
(10) Pub. No.: US 2004/0078309 A1
(43) Pub. Date: Apr. 22, 2004

(54) Systems and methods for evaluating business cases

(75) Inventors: Suzanne M. Norquist, Golden, CO (US); Paul Katz, Boulder, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO

(21) Appl. No.: 10/269,640

(22) Filed: Oct. 10, 2002

(51) Int. Cl. G06F 17/60

(52) U.S. Cl. 705/35

(57) ABSTRACT

A method of evaluating business cases includes receiving into a computing device configuration information relating to the business case. The method further includes presenting data entry screens for entering data into the model. The data entry screens are tailored, based on the configuration information, to the business case. The methods further includes receiving the information into the computing device by way of the data entry screens. The method further includes processing the data to produce a first outcome from the model and displaying the outcome. A further embodiment of the method includes performing a Monte Carlo simulation based on the business case model. Additional embodiments include a system for implementing the method of evaluating business cases.

### CROSS-REFERENCES TO RELATED APPLICATIONS

This application is related to copending, commonly assigned and concurrently filed U.S. patent application Ser. No. ______ (Attorney Docket No. 020366-086800US), entitled “SYSTEMS AND METHODS FOR EVALUATING TELECOMMUNICATIONS PROJECTS,” by Suzanne M. Norquist and Paul Katz, which application is incorporated herein by reference in its entirety for all purposes.

### BACKGROUND OF THE INVENTION

The present invention relates generally to methods and systems for evaluating business cases, and more particularly to methods and systems for creating a model of a business case that allows a user to quickly evaluate a range of possible outcomes for the business case based on variable data.

Many businesses use a structured approach to evaluating proposed projects. The structured approach typically includes an analysis of a proposed project's financial feasibility. Such financial analyses, herein called “business cases”, evaluate, for example, a project's internal rate of return and net present value. However, in many instances, the scope of the business case scales proportionally with the resources the business must commit to implement the proposed project.

For very large scale projects, the business case may be based on hundreds, or even thousands, of variables, many of which can only be estimated to within a very wide range. Thus, it becomes important to making good business decisions to evaluate the business case using as many different values for each variable as practical. Further, some variables may be dependent on the value of other variables, which drastically increases the complexity of the problem. Further still, as projects develop, the range of possible values for variables and even the number of variables may change, thus creating, in many cases, the need to begin the analysis from scratch. Additionally, understanding the degree to which a business case depends on particular variables aides the decision making process. However, current methods for evaluating business cases are limited in their ability to quickly respond to change.

Therefore, the need exists for business case analysis tools that provide a more thorough analysis of business cases more quickly and more flexibly than prior art methods. Further, the need exists for business case development tools that simplify the process for developing business case models by providing a wide range of applicability to many different types and sizes of business cases.

### BRIEF SUMMARY OF THE INVENTION

Embodiments of the present invention thus provide a method for evaluating a business case. The method include receiving configuration information relating to the business case into a computing device, thereby configuring the computing device to display one or more data entry screens tailored, based on the information, to the business case. The method also may include receiving data relating to the business case into the computing device via the one or more data entry screens and processing the data to produce a first outcome from the model based on the data. The method further may include displaying the first outcome.

In other embodiments the method may include receiving different data relating to the business case into the computing device via the one or more data entry screens, processing the data to produce a second outcome from the model based on the data, and displaying the second outcome to a user. The method also may include receiving information indicating one or more of the datum to be variable and defining the possible values for the one or more variable datum, processing the data, including the possible values for the one or more variable datum, to produce a plurality of outcomes from the model based on the data, and displaying the plurality of outcomes to a user. In still other embodiments, the outcome may include a financial statement selected from a group consisting of income statement, balance sheet and cash flow statement. The method may include performing a Monte Carlo simulation of the model using one or more of the variable data and/or displaying a histogram of the different outcomes from the Monte Carlo simulation. The information defining the possible values for the one or more variable datum may include a lowest value, a highest value and an increment for each value between the lowest value and the highest value for each of the one or more variable datum. The method may include producing an outcome from the model for each of the possible values for the one or more variable datum.

In yet other embodiments, the method may include configuring, based on the information relating to the business case, at least one of the one or more data entry screens to detect occurrences of particular information and upon detecting the information, produce an alert indicating the occurrence of the information. The occurrence of particular information may constitute an error. The method may include receiving information relating to one or more geographic regions throughout which the business case could be implemented, and/or receiving information relating to the expected demand relating to the business case in each geographic region based on the population in each of the one or more geographic regions. The method may include receiving pricing data for each of the one or more geographic regions throughout which the business case could be implemented. The pricing data may be different for at least two of the one or more geographic regions. The method may include receiving information relating to the expected demand for each of one or more geographic regions throughout which the business case could be implemented, and/or receiving information relating to the capital equipment to implement the business case. The method also may include receiving information relating to the depreciation method to be used for the capital equipment. The business case may relate to a product or a service.

In still other embodiments, the present invention provides a computer system for evaluating a business case. The computer system includes a storage device, an input device, a display device, a processor, and a communications device configured to exchange data among the storage device, the input device, the display device, and the processor. The processor may be configured to present model configure data screens on the display device, present business case data screens on the display device based on model configuration data, calculate the outcome for the business case based on the model configuration data and the business case data, present a summary of the outcome for the business case on the display device, and store the model configuration data and the business case data on the storage device. The business case model may be developed using a spread sheet. The spread sheet may include a workbook having one or more worksheets.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 depicts a system for evaluating business cases according to one embodiment of the present invention.

FIG. 2 depicts a method of evaluating business cases according to an embodiment of the present invention that may be implemented in a system according to the embodiment of FIG. 1.

FIG. 3 depicts a process for configuring a business case model according to an embodiment of the present invention.

FIGS. 4a-4f depicts a series of dialogue boxes in a wizard for configuring a business case model according to embodiments of the process of FIG. 3.

FIG. 5 depicts a process for entering data into a business case model according to one embodiment of the present invention.

FIG. 6 depicts a worksheet for entering project description data into a business case model according to one embodiment of the present invention.

FIG. 7 depicts a worksheet for entering general & financial data into the business case model according to one embodiment of the present invention.

FIG. 8 depicts an error status dialogue box according to one embodiment of the present invention.

FIGS. 9a and 9b depict first and second views of a worksheet for entering capital types data into the business case model according to one embodiment of the present invention.

FIG. 10 depicts a worksheet for entering service names data into the business case model according to one embodiment of the present invention.

FIG. 11 depicts a first worksheet for entering area names data into the business case model according to one embodiment of the present invention.

FIG. 12a depicts a first view of a worksheet for entering neighborhood description data into the business case model according to one embodiment of the present invention.

FIG. 12b depicts a second view of the worksheet for entering neighborhood description data into the business case model according to one embodiment of the present invention.

FIG. 13 depicts a worksheet for entering neighborhood detail data into the business case model according to one embodiment of the present invention.

FIG. 14 depicts a worksheet for entering population data into the business case model according to one embodiment of the present invention.

FIG. 15 depicts a first view of a worksheet for entering service demand data into the business case model according to one embodiment of the present invention.

FIG. 16 depicts a worksheet for entering add-on service demand data into the business case model according to one embodiment of the present invention.

FIG. 17 depicts worksheet for entering service monthly revenues data into the business case model according to one embodiment of the present invention.

FIG. 18 depicts a worksheet for entering service one-time revenue data into the business case model according to one embodiment of the present invention.

FIG. 19 depicts a worksheet for entering service rollout schedule data into the business case model according to one embodiment of the present invention.

FIG. 20 depicts a worksheet for entering chum data into the business case model according to one embodiment of the present invention.

FIG. 21 depicts a first worksheet for entering equipment data into the business case model according to one embodiment of the present invention.

FIGS. 22a-22c depict views of a second worksheet for entering equipment layout data into the business case model according to one embodiment of the present invention.

FIG. 23 depicts a worksheet for entering equipment layout selection data into the business case model according to one embodiment of the present invention.

FIG. 24 depicts a worksheet for entering additional capital general data into the business case model according to one embodiment of the present invention.

FIG. 25 depicts a worksheet for entering additional capital detail data into the business case model according to one embodiment of the present invention.

FIG. 26 depicts a worksheet for entering additional expenses data into the business case model according to one embodiment of the present invention.

FIGS. 27a and 27b depict error status summary dialogue boxes according to one embodiment of the present invention.

FIG. 28a depicts an output options dialogue box according to one embodiment of the present invention.

FIG. 28b depicts an executive summary worksheet representing the output from the business case model according to one embodiment of the present invention.

FIG. 29a depicts a cash flow worksheet representing additional output from the business case model according to one embodiment of the present invention.

FIG. 29b depicts a cash flow summary worksheet representing additional output from the business case model according to one embodiment of the present invention.

FIG. 29c depicts an income statement worksheet representing additional output from the business case model according to one embodiment of the present invention.

FIG. 29d depicts a balance sheet worksheet representing additional output from the business case model according to one embodiment of the present invention.

FIG. 30a depicts a first cell iterator dialogue box for initiating a feature of one embodiment of the present invention.

FIG. 30b depicts a second cell iterator dialogue box according to one embodiment of the present invention.

FIG. 30c depicts a cell iterator worksheet representing output from the cell iterator feature using the business case model according to one embodiment of the present invention.

FIG. 31 depicts a worksheet having a button for initiating a Monte Carlo simulation feature according to one embodiment of the present invention.

FIG. 32 depicts a process for performing a Monte Carlo simulation using the business case model according to one embodiment of the present invention.

FIG. 33a depicts a first dialogue box in a wizard for configuring a Monte Carlo simulation using the business case model according to one embodiment of the present invention.

FIG. 33b depicts a second dialogue box in a wizard for configuring a Monte Carlo simulation using the business case model according to one embodiment of the present invention.

FIG. 33c depicts a third dialogue box in a wizard for configuring a Monte Carlo simulation using the business case model according to one embodiment of the present invention.

FIG. 33d depicts a fourth dialogue box in a wizard for configuring a Monte Carlo simulation using the business case model according to one embodiment of the present invention.

FIG. 34a depicts a worksheet for entering Monte Carlo simulation data to be performed using the business case model according to one embodiment of the present invention.

FIG. 34b depicts a dialogue box for selecting custom variables for the Monte Carlo simulation to be performed using the business case model according to one embodiment of the present invention.

FIG. 35 depicts a cautionary dialogue box associated with the he Monte Carlo simulation to be performed using the business case model according to one embodiment of the present invention.

FIG. 36 depicts an executive summary, including the results of the Monte Carlo simulation, from the business case model according to one embodiment of the present invention.

FIG. 37a depicts a first dialogue box for altering the appearance of the Monte Carlo simulation results from the business case model according to one embodiment of the present invention.

FIG. 37b depicts a second dialogue box for altering the appearance of the Monte Carlo simulation results from the business case model according to one embodiment of the present invention.

### DETAILED DESCRIPTION OF THE INVENTION

The present invention provides systems and methods for evaluating business cases. A business case is, in simple terms, the financial aspects of a proposed project, especially a project involving some capital investment. Before deciding to implement a proposed project, a company typically will evaluate the business case to determine, for example, the profitability of the proposed project, its payback period, its internal rate of return, its net present value, as well as other factors. Because projects, especially large scale projects, may include a number of unknowns or variables, it is beneficial to the decision making process to evaluate business cases using computer models. A computer model makes possible evaluating a business case using a number of different values for the variables that may affect the proposed project financially. One aspect of the present invention is to provide tools that include a number of different alternatives for developing computer models for evaluating business cases. Another aspect of the present invention is to provide the ability to evaluate a business case using many different values for one or more variables and generate statistical financial data based on the evaluation.

Attention is first directed to FIG. 1, which illustrates one embodiment of a system for evaluating business cases 100. The system 100 includes a computing device 102, one or more databases 104 and a network 106 connecting the computing device to the one or more databases. The system 100 also may include other computing devices 108 interconnected through the network 106, as well. The computing device 102 can be a desktop personal computer, a work station, a personal digital assistant (PDA) or any other suitable computing device. The computing device 102 might include one or more data entry devices, such as, for example, a keyboard, a mouse and/or a touch screen. The computing device 102 might also include one or more devices for receiving and viewing the results of the analyses, such as, for example, a printer and video monitor. Although illustrated as being connected to a network 106, another embodiment of the present invention may be configured without a network. For example, the present invention may include or operate within a standalone computing device or a computing device having direct connections to the database and other computing elements. Further, the present invention does not necessarily require a database. However, in embodiments that include a database, the one or more databases 104 may be any means for storing data and/or other information that allows retrieval through the use of a computing device. The network 106 can be a local area network (LAN), a wide area network (WAN), a virtual private network (VPN), the Internet, or the like.

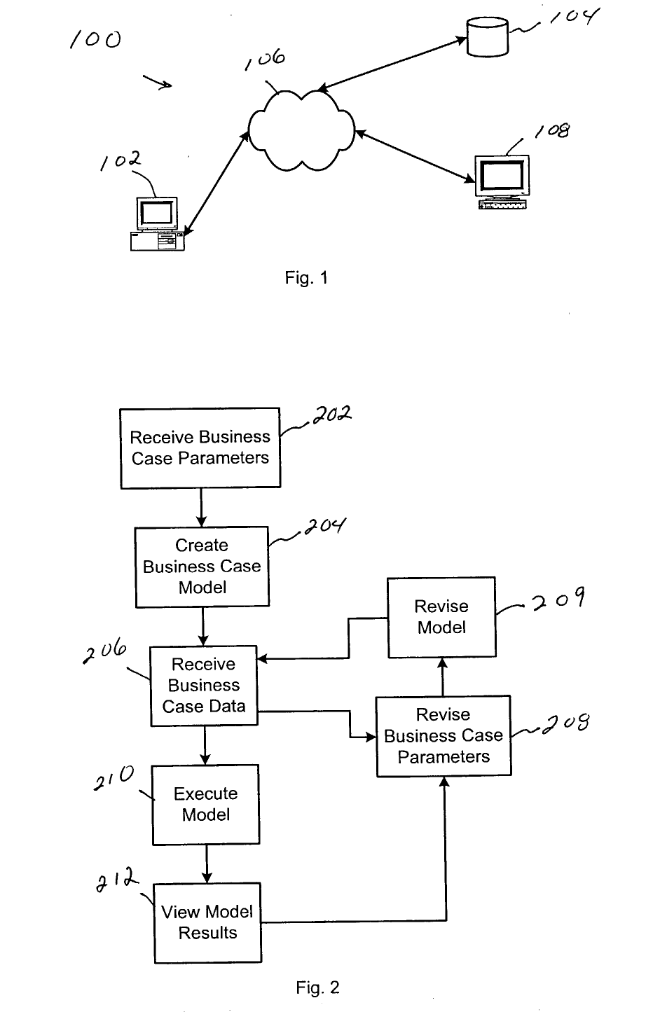

Attention is now directed to FIG. 2, which illustrates a first embodiment of a method for evaluating business cases provided by the present invention. The method 200 begins by receiving business case parameters into a computing device at operation 202. At operation 204, a computer model is created based on the parameters received at operation 202. Model data is then received into the model at operation 206. During the data receiving operation 206, revised parameters that define the business case may be received as illustrated at operation 208, and the model may be revised at operation 209. Once sufficient data is received to produce meaningful results, the model is executed at operation 210. The results may be displayed, as shown at operation 212, on the computing device, on paper, or through other suitable means. As one skilled in the art will appreciate, it is possible to perform operations 208, 209, 206, 210 and 212 over a number of iterations to test a number of different business cases.

Now that the method of evaluating business cases according to the present invention has been described generally, the various operations in the method 200 will be described in greater detail. In order to more clearly illustrate the present invention, a specific embodiment of the present invention will be used as an example throughout the remainder of this detailed description. However, the present invention is not limited in any way by the specific embodiment used as an example herein, and those skilled in the art will realize, in light of this disclosure, many additional ways to embody the present invention. Further, this example of the present invention relates to a telecommunications project. However, the present invention may apply equally to many other types of projects, as those skilled in the art appreciate.

Those skilled in the art will easily recognize the specific example used herein to include an electronic spreadsheet. A number of commercial spreadsheet computer software programs are available that could provide the core spreadsheet functions of this specific example. However, this example of the present invention greatly expands on the basic functions provided by such commercial programs in ways heretofore unseen. Further, the present invention is not limited to commercial spreadsheet programs specifically or either commercial or spreadsheet programs generally. The present invention could be implemented, for example, in a system that includes a relational database program. Alternatively, the present invention could be implemented using an environment heretofore unknown using no commercial software programs or concepts.

Because the specific example of the present invention described herein includes a commercial spreadsheet, many aspects of the present invention will be illustrated through the use of well-recognized commercial software and spreadsheet functions. For example, the present invention will make use of “drop-down menus” for selecting various functions, some of which functions are standard to commercial software, some of which are specific to this example of the present invention. This example of the present invention will also include “tool bars” having “buttons” for accessing functions, some of which are also available as menu items. This example also includes “wizards”, a well-known tool for assisting with performing a series of operations. Of course, standard navigation and image manipulation tools also are included, for example, scroll bars, “open” window, “close” window and “minimize window” buttons, “forward” and “back” buttons, “cancel” and “OK” buttons, “finish” buttons, etc.

As to spreadsheets, this example of the present invention includes rows and columns of “cells” for receiving data, functions, notes, labels or text. The content of cells can be configured to depend on the content of other cells. A worksheet is a two dimensional arrangement of cells grouped into rows and columns. A collection of worksheets make up a workbook. The content of a cell on a worksheet can also be made dependent on the content of a cell on a different worksheet or even a different workbook. Other familiar spreadsheet concepts will be apparent to those skilled in the art, none of which limit the scope of the present invention.

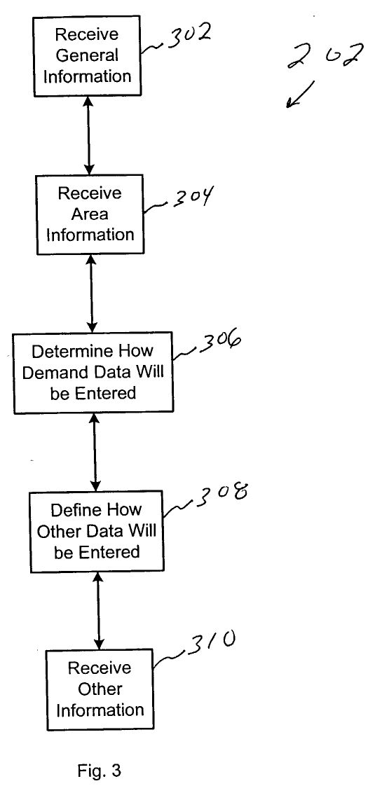

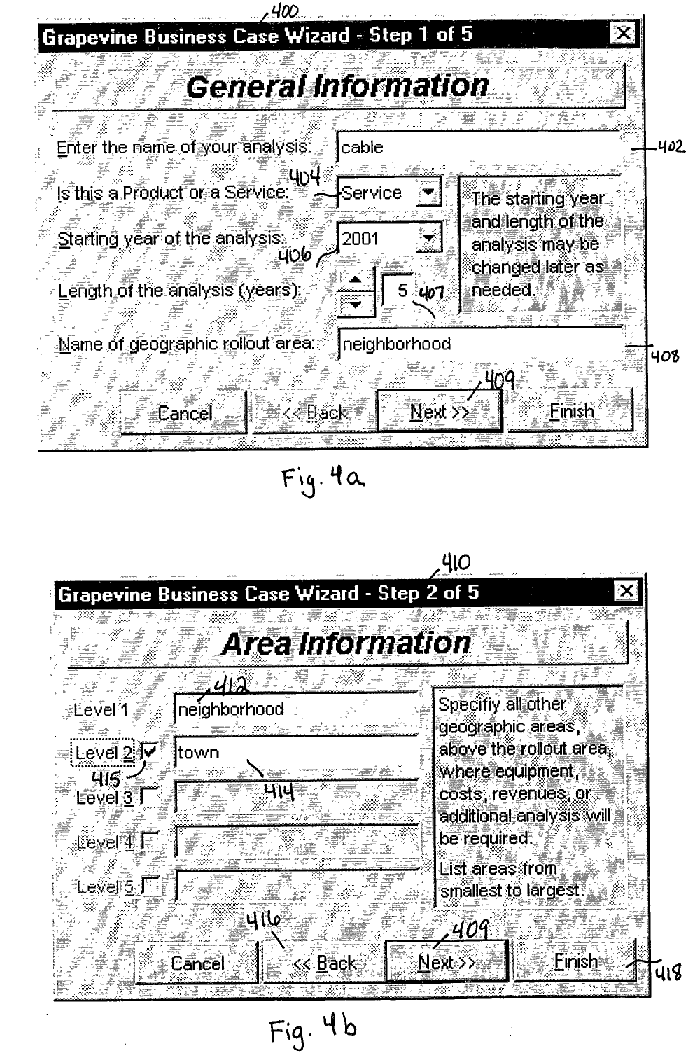

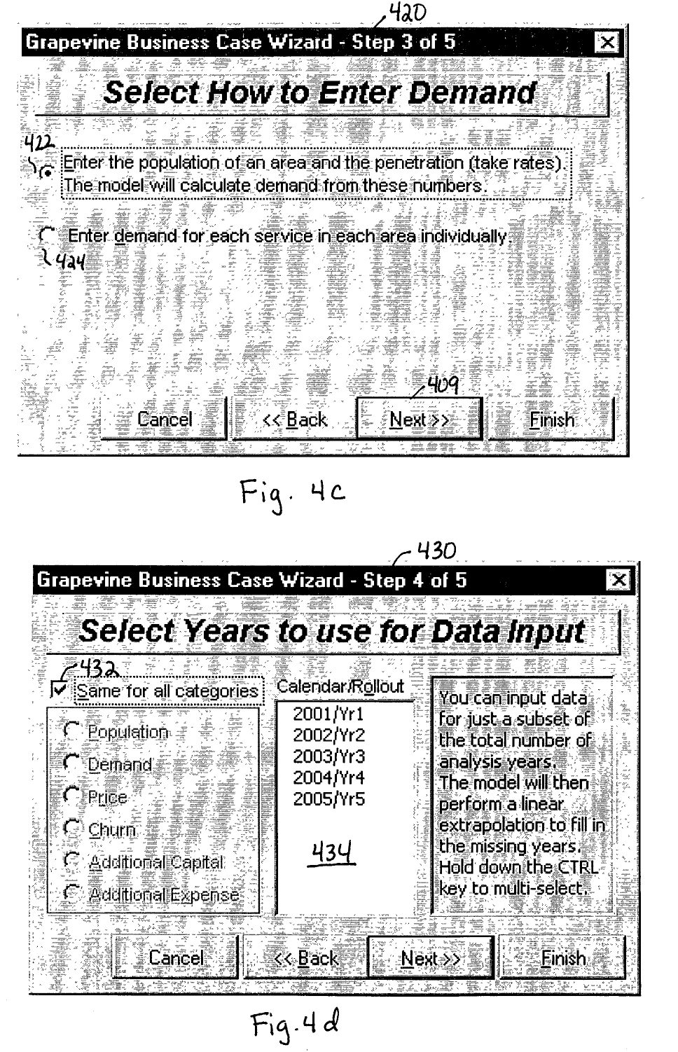

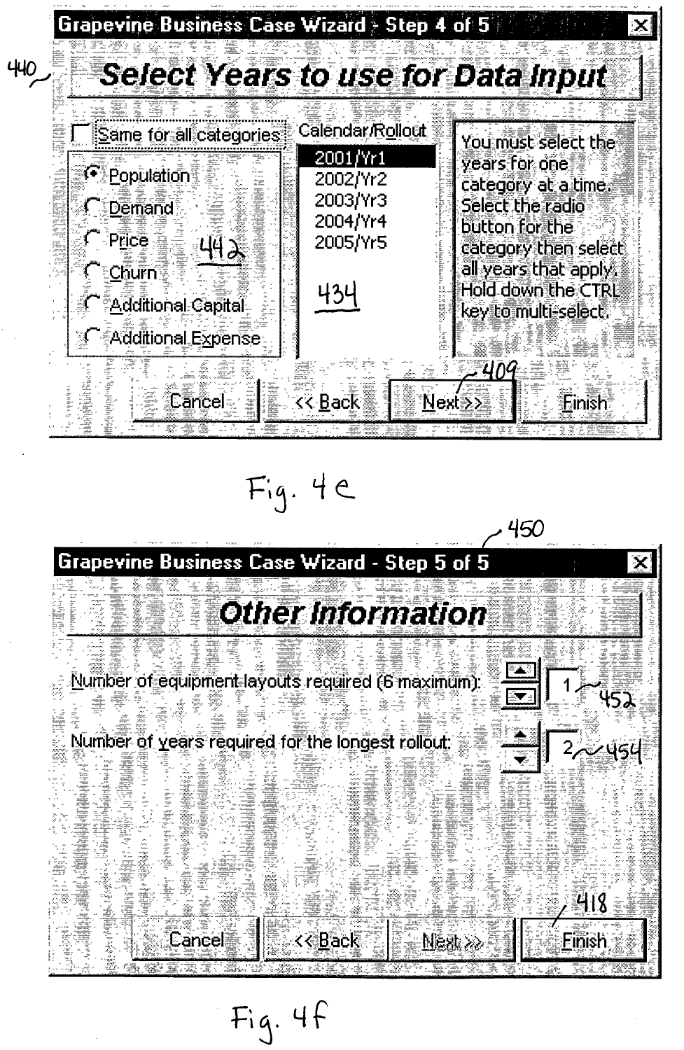

Attention is now directed to FIG. 3, which illustrates in greater detail the receiving business case parameters operation 202. The various operations illustrated in FIG. 3 will be better understood with reference to the screen display images of FIGS. 4a-4f. The screen display images of FIGS. 4a-4f represent a series of dialogue boxes in a wizard. In this example of the present invention, the wizard assists with configuring a business case model. The model is based on the parameters received into the computing device as part of operation 202. Thus, depending upon the specific parameters received, the business case model may have any one of many different forms.

Operation 202 begins with step 302, receiving general information. In this example of the present invention, general information is received through a “step one” dialogue box 400 in FIG. 4a. The step one dialogue box includes data fields into which information and data are entered for receipt by the computing device. For example, the name of the analysis may be entered into a name field 402. An indication as to whether the analysis applies to a service or product may be entered into a “product/service” field 404. The starting year for the analysis may be entered into a “starting year” field 406, and the length of the analysis may be entered into a length field 407. General information also may include the name of the geographic roll out area for the business case. The geographic rollout area is the smallest incremental division of the total area over which a project might be implemented. For example, the geographic rollout area might be a neighborhood, and a number of neighborhoods might make up a town. A group of towns might make up a city, and so on. In this example, the name of the geographic rollout area may be entered into a “rollout area” field 408. Using a typical pointing device, such as a mouse or a touch screen, a “next” button 409 may be selected, which would cause a step 2 dialog box 410, FIG. 4b, to be presented.

Operation 202 continues at step 304, receiving area information. Area information includes each geographic level over which the project might be implemented. In this example, the lowest level is the neighborhood level, as illustrated by a “level 1” field 412, which data was previously entered during operation 302. The next higher geographic level is identified by entering an appropriate name in a “level 2” field 414. Although not illustrated in this example, different levels may be used, and each level may be given a unique name. The level names need not be geographic terms. Names such as A, B and C could be used. A checkbox 415 is used to indicate the use of each geographic level above the lowest.

The step 2 dialogue box 410 also includes navigation buttons, including the next button 409, a back button 416 and a finish button 418. The back button 416 would cause the computing device to redisplay the step 1 dialogue box 400 which would be desired, for example, to alter the name of the geographic rollout area in this particular case. Once all the area information is entered into the step 2 dialogue box 410, the next button 409 may be selected to initiate the next operation. Alternatively, if at any point, sufficient information has been entered to define the business case parameters, the finish button 418 may be selected.

The receiving business case parameters operation 202 continues at step 306, determining how demand data will be entered, which operation is illustrated with reference to FIG. 4c. FIG. 4c illustrates a step 3 dialogue box 420. This example of the present invention provides two options for selecting how demand data will be entered. Demand may be entered as a function of population and demand rate, or demand may be entered for each area individually. For example, in the case of a telecommunications project proposed for an existing customer area, demand figures for various geographic areas may be fairly well known, in which case more accurate results may be obtained by using actual demand figures. Either option may be chosen by selecting a radio button, either an option 1 radio button 422 or an option 2 radio button 424. Once again, the next button 409 may be selected to proceed with the next operation in defining business case parameters.

The defining how other data will be entered step 308 is illustrated with reference to FIG. 4d and a step 4 dialogue box 430. As will be described in more detail hereinafter, in this example, data is entered for various categories and years, either calendar years or rollout years. Data for each category may be entered over the same range of years by selecting a checkbox 432. The range over which data will be entered is indicated in a calendar/rollout window 434. Alternatively, by deselecting the checkbox 432 additional options for entering data are provided. The options are illustrated in FIG. 4e, which depicts a second view of the step 4 dialogue box 440. In the step 4 dialogue box 440, categories may be individually selected from a list 442 and specific years for entering data may be selected from the calendar/rollout window 434. Selecting the next button 409 initiates the final step in the receiving business case parameters operation 202.

The receiving other information step 310 is illustrated with reference to a step 5 dialogue box 450 of FIG. 4f. Using an “equipment layout” field 452, the number of equipment layouts required to analyze the business case is selected. For example, in the telecommunications field, the equipment layout may comprise a central office, remote terminals, or nodes, fiber optical cable, and the like. The number of years required for the longest roll out to be analyzed by the business case is selected using a years field 454.

Selecting the finish button 418 completes the receiving business case parameters operation 202.

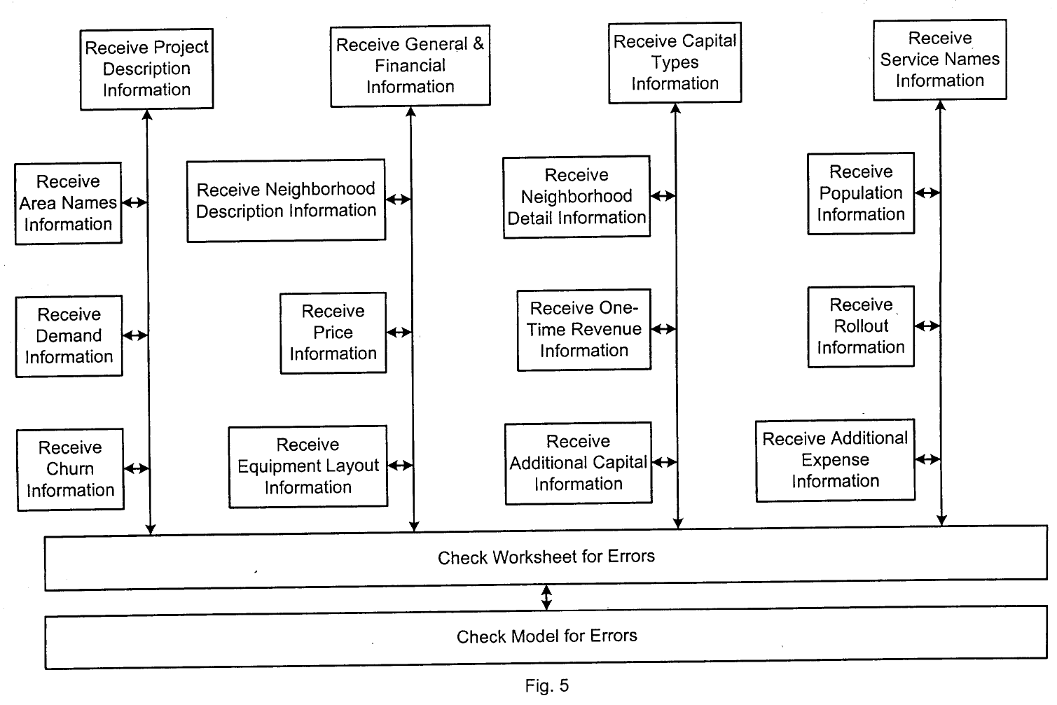

Once the business case model parameters have been defined, a business case model is created at operation 204 of FIG. 2. In this example of the present invention, the model includes a number of data worksheets into which data are entered. FIG. 5 generally illustrates the “receiving model data” operation 206 according to one embodiment of the present invention. However, other possibilities for entering model data exist. The receiving model data operation is further explained through an example and illustrated with reference to the following figures, which depict a number of data worksheets.

Referring to FIG. 6, a project description worksheet 600 is illustrated for entering project description information about the business case. The project description worksheet 600 may include a field 602 for entering the name, business organization or other descriptive information about the person or entity responsible for creating the business case. The same type of information also may be entered in a field 604 for the entity or person to whom the business case is presented. Any number of other fields may be provided for entering business case-related information, such as, for example, a “business problem” field 606 for describing the problem in greater detail, a “project summary” field 608 for describing the proposed business case in greater detail, a “sponsors” field 610 for identifying the persons or business entities supporting the proposed business case, and even an “additional information” field 612 for supplying any other information the user considers relevant to the business case and desires to include in the business case analysis.

The information supplied through the project description worksheet 600 may be included, for example, in a coversheet or introductory section of a printed version of the business case. Alternatively or additionally, the information may be accessible to other users or decision makers who access the business case electronically.

The project description worksheet 600 also illustrates a number of features common to spreadsheets generally. For example, standard drop-down menus 614 are provided for accessing standard spreadsheet functions. Also, standard toolbar buttons 616 are provided for accessing spreadsheet functions without having to first pull down a menu. A worksheet navigation tool 618 is provided that includes buttons 620 for moving through the worksheet tabs 622. Other features, such as scroll bars, function bars and information bars, are also included, although not fully explained herein, since such standard features are apparent to those having skill in the art.

In addition to the common spreadsheet features mentioned above, the project description worksheet also illustrates button menu or toolbar 624, which contains a number of buttons that access custom features provided by this example of the present invention. Several of the custom features will be explained in more detail below.

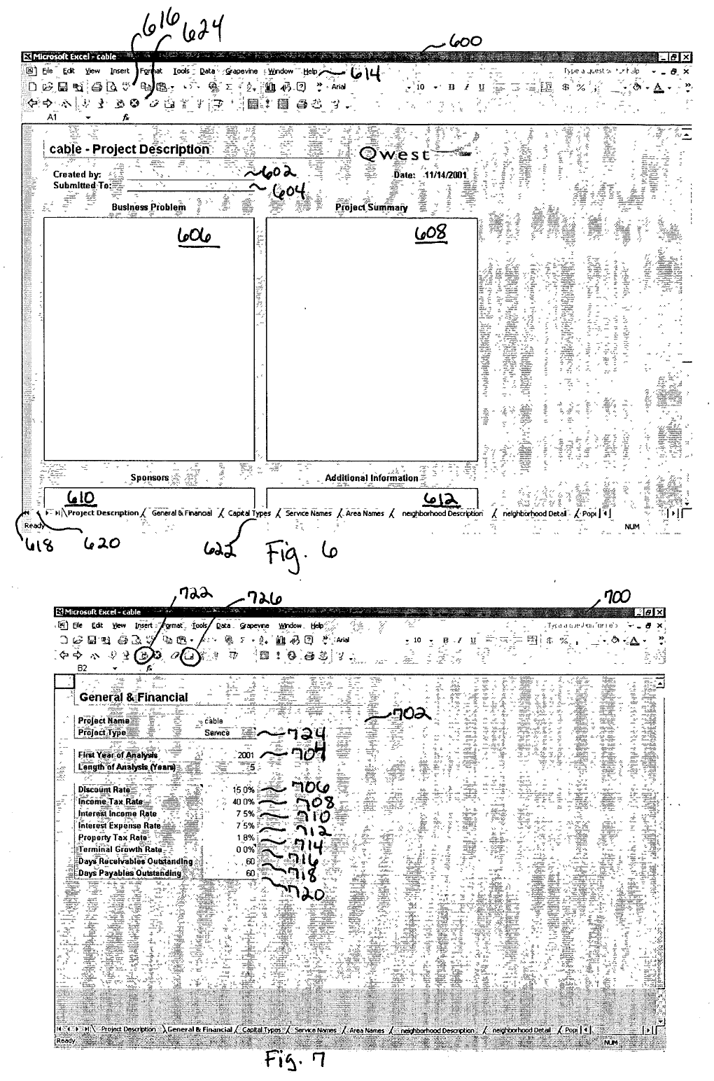

Having entered information into the project description worksheet 600, the user may select one of the tabs along the bottom of the screen to access another data entry worksheet, for example, a “general & financial” worksheet 700, illustrated in FIG. 7. In this example of the present invention, the worksheet 700 is for entering financial and other information into the business case model. Such information may include the project name and the base year of the analysis, both of which are entered into their respective fields 702, 704. Other data to be entered into the general & financial worksheet 700 include: the discount rate 706, the income tax rate 708, the interest income rate 710, the interest expense rate 712, the property tax rate 714, the terminal growth rate 716, the number of days receivables are outstanding 718, and the number of days payables are outstanding 720. Each of these financial variables potentially can affect the financial projections and ultimate viability of the business case in ways well known to those having skill in the art.

The general & financial worksheet 700 of FIG. 7 also illustrates custom features provided by this example of the present invention. The page error check button 722 accesses a page error information screen 800, illustrated in FIG. 8, that identifies any errors that may have been committed with respect to the entry of data into the present worksheet. Although illustrated for a different worksheet (i.e., not the general & financial worksheet 700), the function of the page error information screen 800 should be apparent in light of the following discussion. Each data entry field of each worksheet may include logic to evaluate the correctness of data entered therein. For example, the logic may indicate that an error exists with respect to the discount rate 706 if the user were to enter a discount rate that was either too high or too low. Of course, a part of the logic would be a definition of the suitable range for the discount rate. In the example of FIG. 8, no errors were detected with respect to the data entered in the service names worksheet (to be discussed below).

The general & financial worksheet 700 of FIG. 7 also illustrates the note feature of this example of the present invention. The presence of the note icon 724 in a cell indicates that additional information is available for review by a user. The note may provide information that aids a user in entering data into the cell. For instance, the note may provide a user with information used by the logic function explained above to evaluate the suitability of the item of data. Alternatively or additionally, a note may be entered into a cell by selecting the cell then selecting the add note button 726. In response, this example of the present invention provides a user with a note screen into which notational information may be entered.

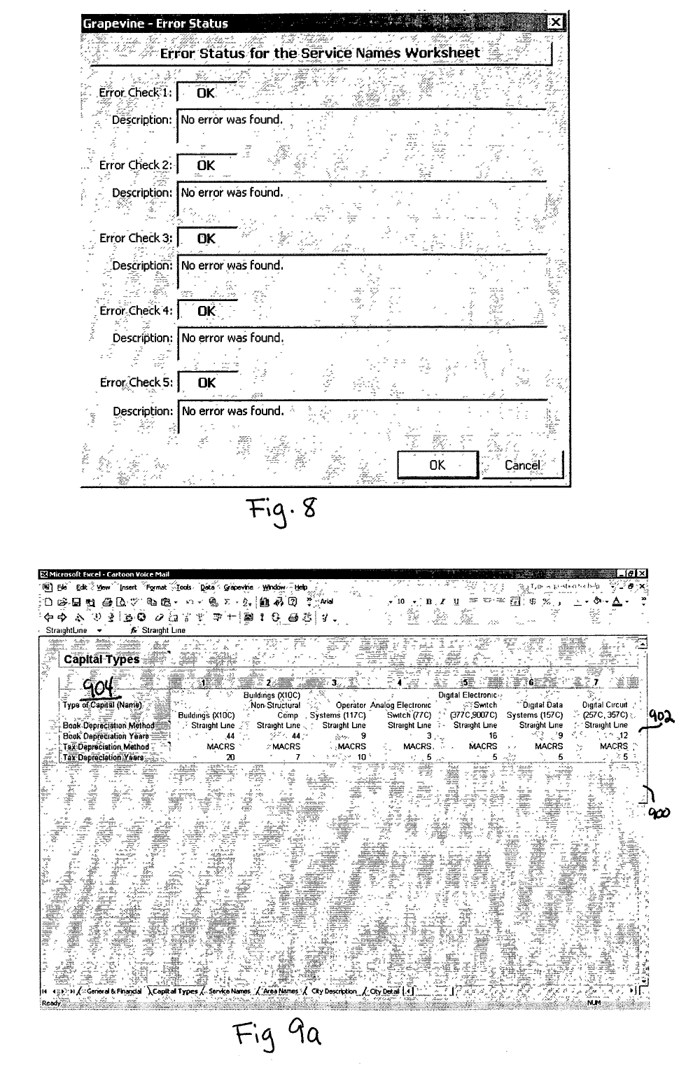

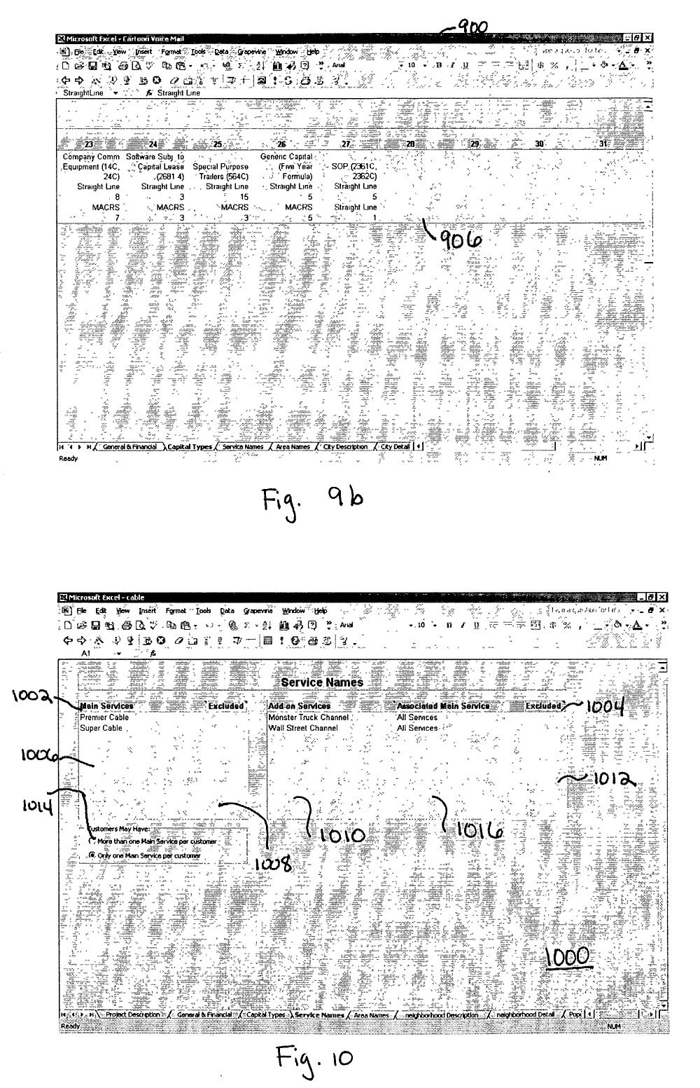

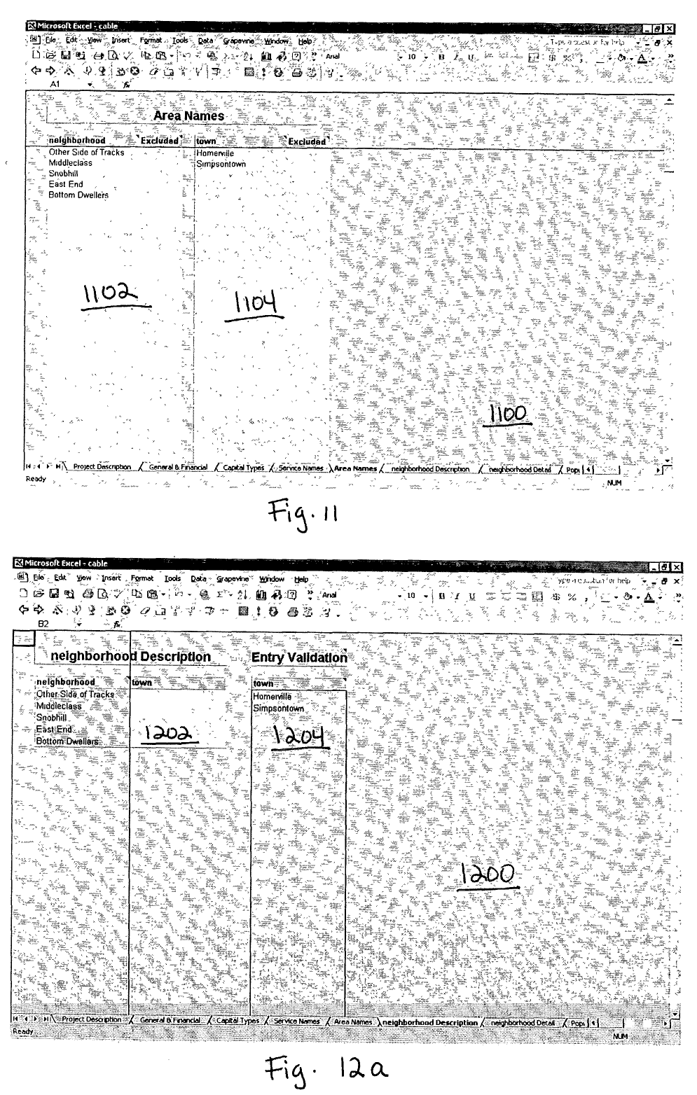

Having entered appropriate data into the general & financial worksheet 700, data may be entered into another worksheet such as the capital types worksheet 900 illustrated in FIGS. 9a and 9b. The capital types worksheet 900 provides a number of possible capital categories 902 that the business may use, and for each, specifies the associated depreciation methods 904. Depreciation methods are provided for both book value accounting and tax accounting, as well as the number of years of depreciation for each. In this example, the user may scroll from left to right to see the number of different categories provided by the model. As can be appreciated, FIG. 9b illustrates columns of the worksheet to the far right of those illustrated in FIG. 9a. If the user does not see a capital type needed for the business case, then additional columns 906 are provided for entering the appropriate information for the needed capital types. The user may then proceed with error checking the capital types worksheet 900 and/or selecting a tab for another worksheet.

Having completed the necessary actions with respect to the capital types worksheet 900, the user may proceed with entering data into, for example, the service names worksheet 1000 illustrated in FIG. 10. The service names worksheet 1000 allows the user to define the main services 1002 of the business case and any add-on services 1004, and the relationship between the two. Add-on services are available after a customer has purchased a main service. For example, in the case of a cable system, a main service may be basic cable and an add-on service may be a premium channel. In another example, a main service may be local phone service and an add-on service may be DSL. The user enters the name of each service in the field 1006 and indicates if the service is to be excluded from the analysis by entering “yes” in the excluded field 1008. The excluded field 1008 allows the user to alternately include and exclude certain services from various scenarios evaluated though the use of the business case model. Similar fields 1010 and 1012 are provided for add-on services. The selection box 1014 allows the user to indicate whether customers select only one or any number of main services. The service names worksheet 1000 also allows individual add-on services to be associated only with particular main services. This association is indicated by entering appropriate information in the associated main service field 1016.

Although the services name worksheet 1000 appears to limit the present invention to services, this is not the case. The present invention may also be used to evaluate business cases involving products, in which case a similar worksheet would be available to the user for entering product information. Because in the present example, the election was made (while configuring the business case model at operation 302 of FIG. 3 using field 404 of FIG. 4) to evaluate a business case involving services, only the service names worksheet 1000 will be discussed in detail herein. However, it is now apparent to those skilled in the art how the present invention may equally apply to business cases involving products.

Having entered data into the services names worksheet 1000, data may be entered into, for example, the area names worksheet 1100. In the general information configuration operation 302 of FIG. 3, an election was made for the present example to evaluate the present business case at the neighborhood level (field 408 of FIG. 4a). Then in the area information configuration operation 304 of FIG. 3, an election was made to associate the neighborhoods with towns (field 414 of FIG. 4b). Thus, the area names worksheet 1100 provides fields 1102 and 1104 for naming the neighborhoods and towns respectively. Excluded fields 1106 and 1108 are also provided for selectively excluding neighborhoods and/or towns respectively from the analysis.

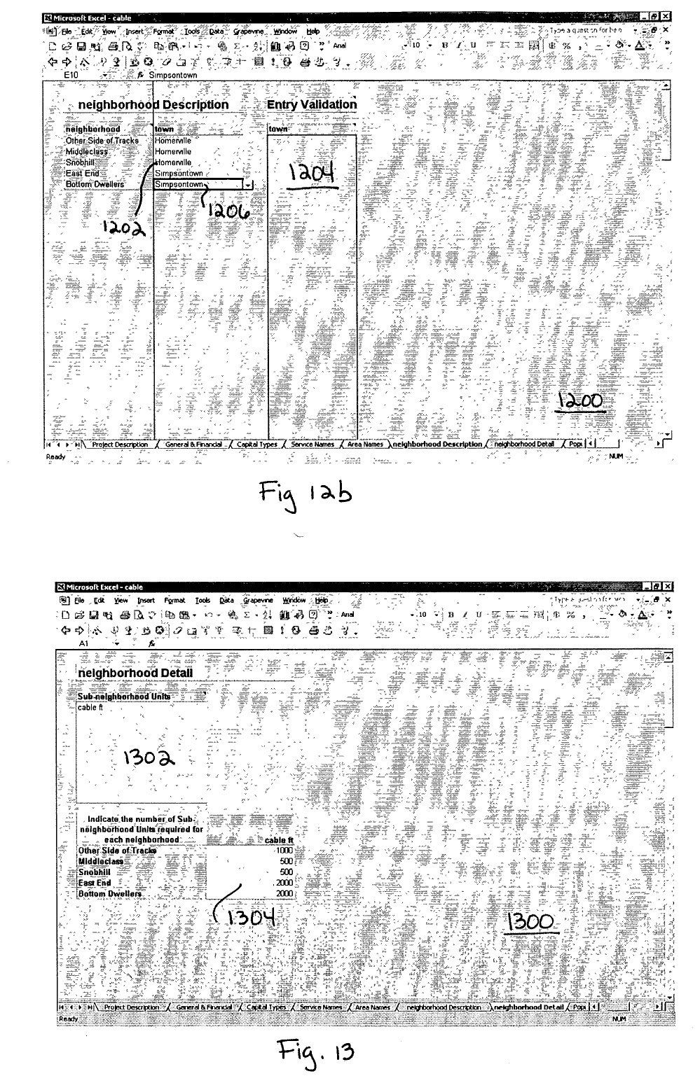

The neighborhood description worksheet 1200, illustrated in FIGS. 12a and b, associates each neighborhood with a town. The worksheet 1200 includes fields 1202 for entering a town for each neighborhood. In this example, each town must be used at least once. As an aid for ensuring this, the worksheet 1200 includes an entry validation tool 1204 that lists each town supplied by the user in the area names worksheet 1100. As town names are entered into the fields 1202, the name of the town is removed from the entry validation tool 1204, as can be appreciated with reference to FIG. 12b. The entry of data into fields 1202 may be aided through the use a tools such as drop-down menu 1206. This example of the present invention illustrates the use of towns subdivided into neighborhoods; however, may other divisions are possible.

FIG. 13 illustrates neighborhood detail worksheet 1300, through which the user may enter more detailed parameters for each smallest geographic unit, in this example, each neighborhood. In a sub-neighborhood units field 1302, the user lists all such items particular to the business case. A separate column 1304 is provided for each entry, thus allowing the user to quantify each sub-neighborhood unit for each neighborhood. For example, in the telecommunications embodiment illustrated in FIG. 13, the number of feet of cable required for a sub-neighborhood might be entered. As one skilled in the art will appreciate, other neighborhood detail information may be entered, such as the number of nodes, hubs switches, etc.

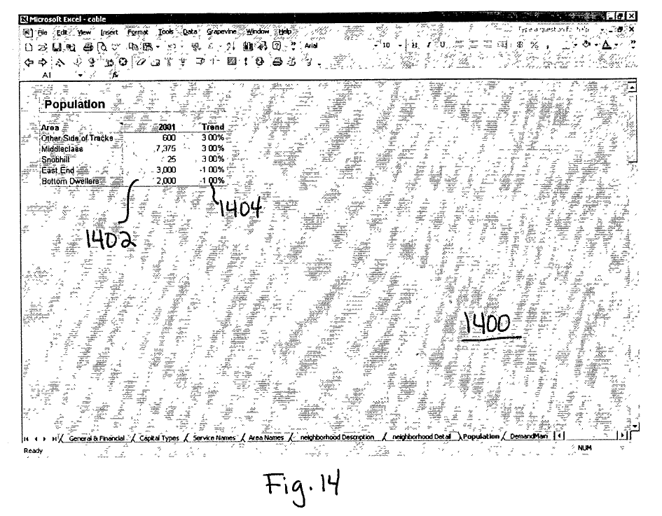

FIG. 14 illustrates the population worksheet 1400 wherein data related to population for a base year may be entered into an appropriate field 1402. In some embodiments of the present invention, population data may be extracted from other workbooks or databases. Population trends for each area may also be entered into the trends field 1404. Population is included in this example of the present invention because population-based demand was selected during the demand configuration operation 306 of FIG. 3 (see selection field 422 of FIG. 4c).

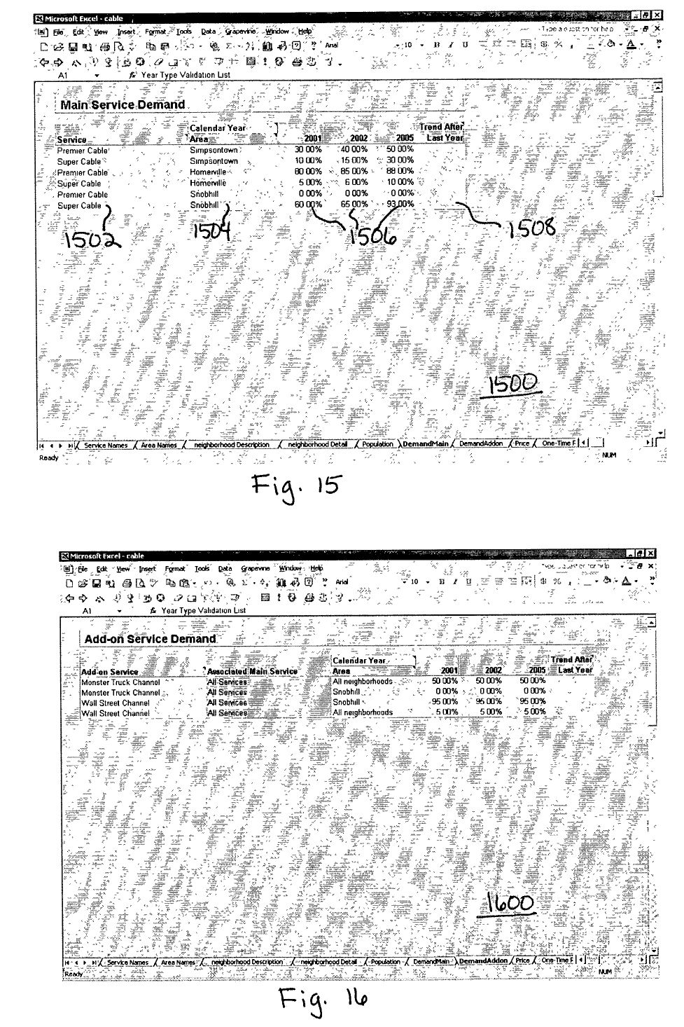

FIG. 15 illustrates the main service demand worksheet 1500. This worksheet is used to enter demand forecasts for each service in the various areas. The worksheet 1500 includes fields for service 1502, area 1504, and each year 1506 for which demand was configured to be entered (see operation 308 of FIG. 3 and fields 442 and 434 of FIG. 4e). Demand is entered as a percentage for each year of the analysis. Each demand column 1506 represents the cumulative demand up to the particular year. Additionally, the worksheet 1500 includes a trend field 1508 for specifying how demand changes after the last year listed. A similar worksheet 1600 is provided as illustrated in FIG. 16 for entering add-on service demand information. In some embodiments, demand data may be extracted from other databases or worksheets.

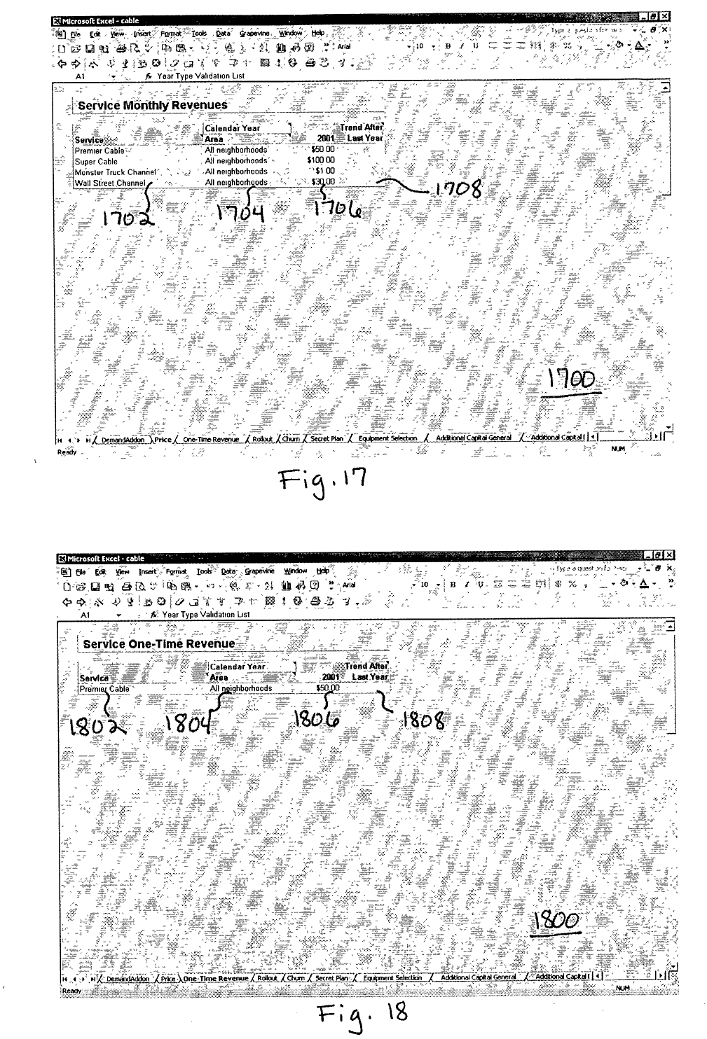

The price worksheet 1700, illustrated in FIG. 17 provides for the entry of price data for each service. According to this example, different areas can have different pricing structures. The worksheet 1700 includes a service field 1702 for entering the name of each service and an area field 1704 for entering the name of the geographic area to which a price applies. The actual pricing data is entered into one or more year fields 1706. Thus, the price worksheet provides the ability for each geographic area to have a different price for each year of the analysis. The trend field 1708 allows for defining how the price changes for years after those specified in the analysis.

The one-time revenue worksheet 1800 in FIG. 18 provides for the entry of revenue associated with the initiation of the service. In the present example, the one-time revenue represents an “installation” fee. For example, with respect to a telecommunications project, the installation fee may be the fee to have a technician install customer premises equipment (CPE) in the customer's home. Data are entered into worksheet 1800 similar to the manner in which data were entered into the price worksheet 1700. A service field 1802, a geographic area field 1804, one or more year fields 1806, and a trend field 1808 are provided.

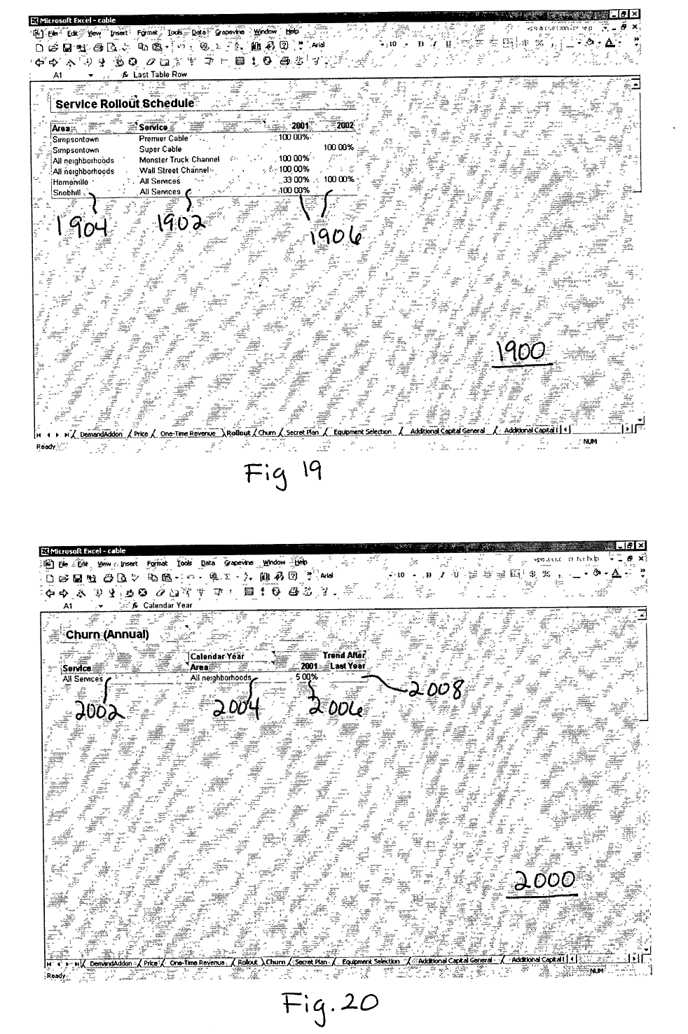

The service rollout schedule 1900 of FIG. 19 allows the user to define a particular schedule for when each product or service will be available to customers in each geographic area. A service filed 1902 is provided for identifying each service individually. An area field 1904 is provided for identifying different rollout schedules for each service in different geographic areas. The rollout data are entered as a percentage into one or more year fields 1906 to indicate the percentage of the area eligible for the service in each particular year.

A churn worksheet 2000 of FIG. 20 provides the ability to define the degree to which customers “turnover” (i.e., degree to which customers are gained and lost within the customer base to result in the net demand projections). The worksheet 2000 provides a service field 2002, an area field 2004, a year field 2006, and a trend field 2008. As with several of the previously described worksheets, different chum projections may be entered for each service and each geographic area in each year of the analysis.

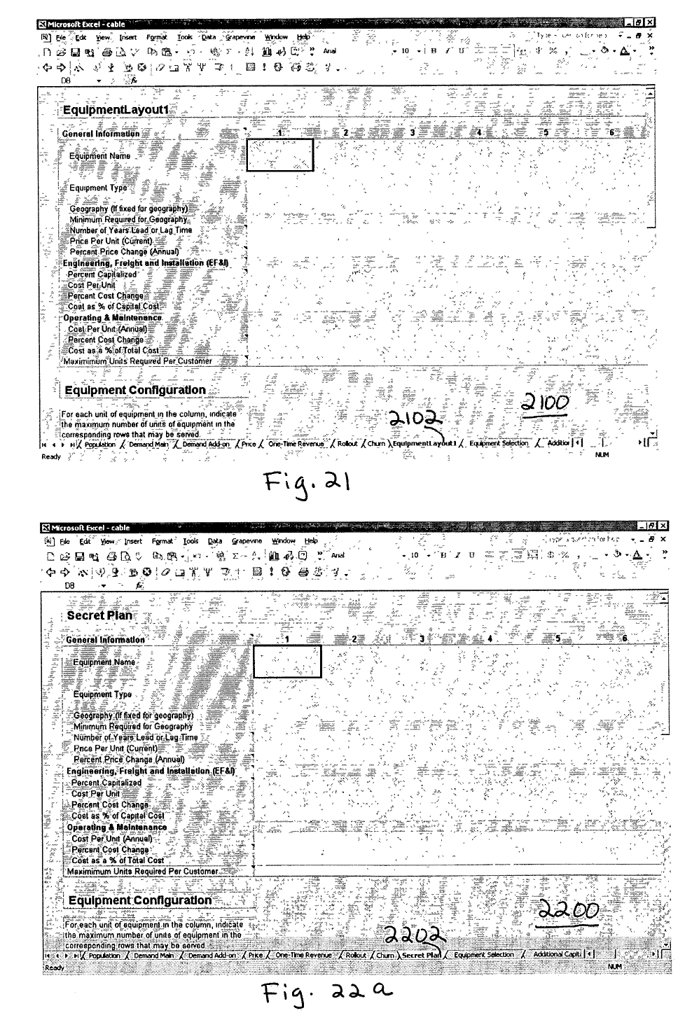

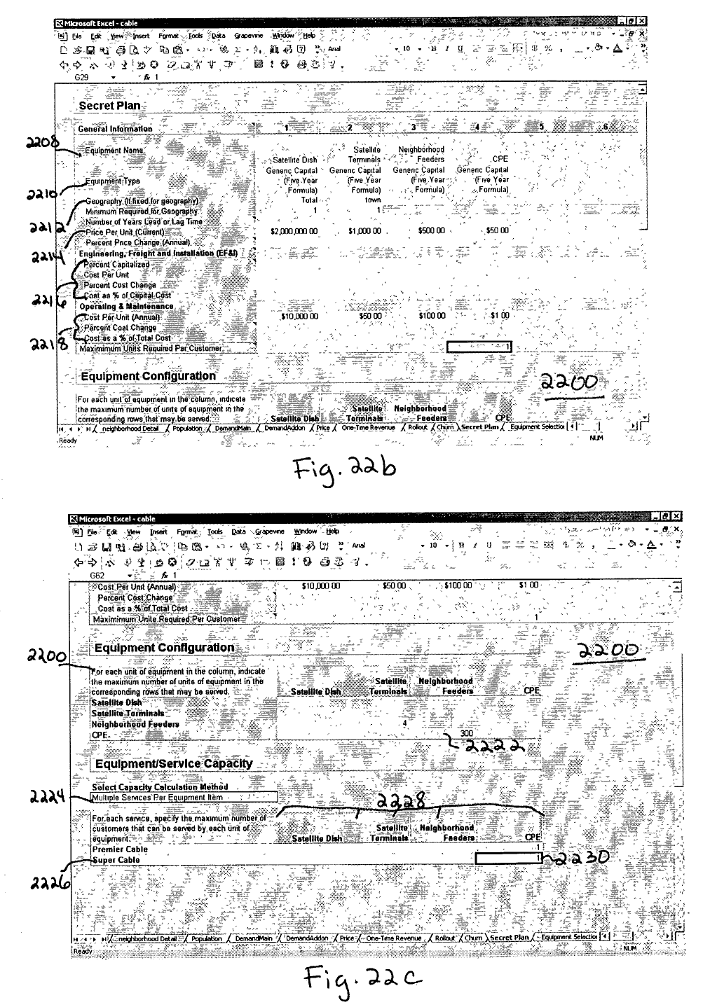

An equipment layout worksheet 2100 of FIG. 21 allows for defining a hardware configuration to support the products or services being analyzed. Multiple equipment layout worksheets may be used, the number being determined by the selection made during the “defining how other data will be entered” step 308 of FIG. 3 (see field 452 of FIG. 4f). Because the number of equipment layout worksheets provided may be greater than one, this example of the present invention allows each worksheet to have a unique name. Thus, the equipment layout tab 2102 may be renamed as shown by a “secret plan” tab 2202 in FIG. 22a, which also changes the title 2204 of the worksheet. In other words, “equipment layout worksheet 2100” is synonymous with “secret plan worksheet 2200” herein.

The secret plan worksheet 2200 provides a great degree of flexibility in defining the infrastructure necessitated by the project which is the subject of the business case. FIGS. 22b and 22c are upper and lower views of the same secret plan worksheet 2200, as will be appreciated by those having skill in the art. The worksheet 2200 includes one or more equipment item columns 2206, one for each item of equipment required by the plan. An equipment name field 2208 is provided for each equipment item. A number of other fields are provided, each having some relationship to the analysis. It is apparent to those skilled in the art how different embodiments of the present invention may include different fields for entering data relating to the equipment required by proposed plans. In this example of the present invention, representative ones of the fields include: an equipment type field 2210 (related to the capital types worksheet 900 of FIG. 9); a geography field 2212 for defining the geographic areas to which equipment pertains; a price per unit field 2214; a number of fields in a non-recurring cost section 2216; and a number of fields in a recurring costs section 2218.

In an equipment configuration section 2220, best appreciated with reference to FIG. 22c, the user may define the relationship among the different types of equipment. A column and a row are provided for each equipment item entered in the equipment item columns 2206. The intersection of each row and column, such as intersection field 2222, define the numerical relationship between the particular items of equipment listed. In other words, in the present example, each neighborhood feeder can support 300 CPEs. In this example related to a cable system, CPE might be cable boxes in customers' homes.

In this example of the present invention, the secret plan worksheet 2200 also provides an equipment/service capacity section 2224 that allows the user to define the number of customers that can be supported by each item of equipment. Each service is listed in a service field 2226, and each item of equipment is listed in an equipment item field 2228. Fields 2230 are provided for entering data relating to the number of customers that can be supported by each equipment item for each service.

This example of the present invention illustrates only one equipment layout worksheet. However, as previously mentioned, depending on the data entered into certain of the data fields during the configuration operation, additional equipment layout worksheets are possible.

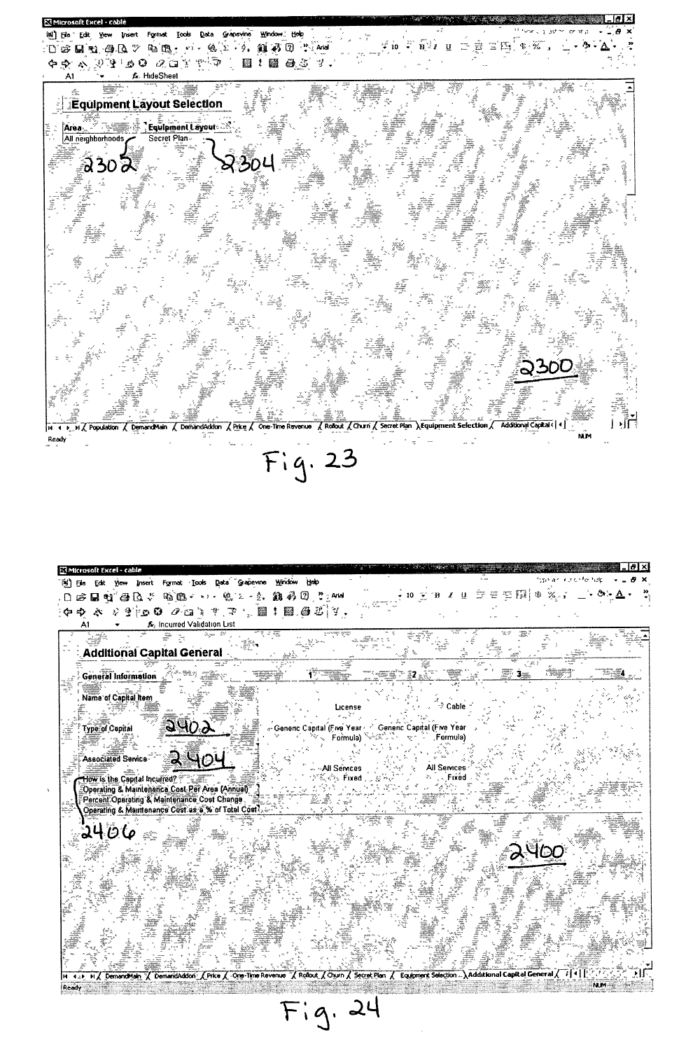

Equipment layout selection worksheet 2300, illustrated in FIG. 23, allows the user to assign a different equipment layout to each geographic area. Geographic areas are listed in the area field 2302, and the appropriate equipment layout for the geographic area is identified in the equipment layout field 2304.

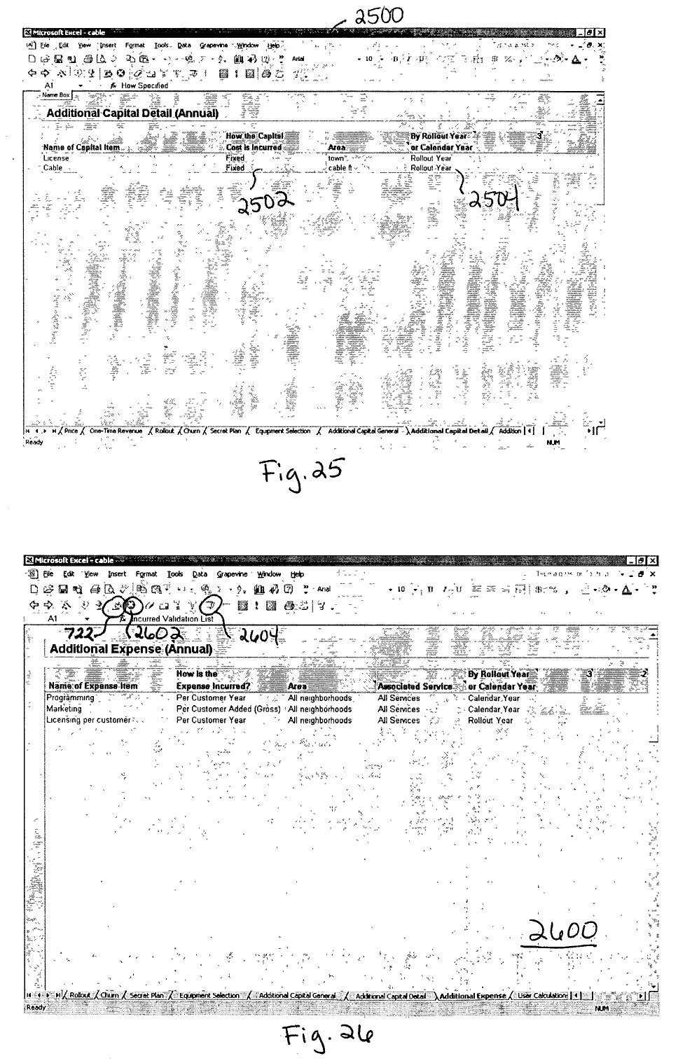

The additional capital general worksheet 2400 and the additional capital detail worksheet 2500, FIGS. 24 and 25 respectively, together allow additional capital requirements to be defined. A number of fields are provided that allow the user to define, for example, the type of capital and thus the depreciation methods (field 2402), the products or services to which the additional capital applies (field 2404), and the basis upon which the capital is incurred (field 2406, 2502). Additionally, fields are provided to associate the additional capital with a particular point in time (e.g., rollout year, field 2504).

Another worksheet, the additional expense worksheet 2600, is provided to identify any additional expenses and associate the additional expenses with a particular point in time.

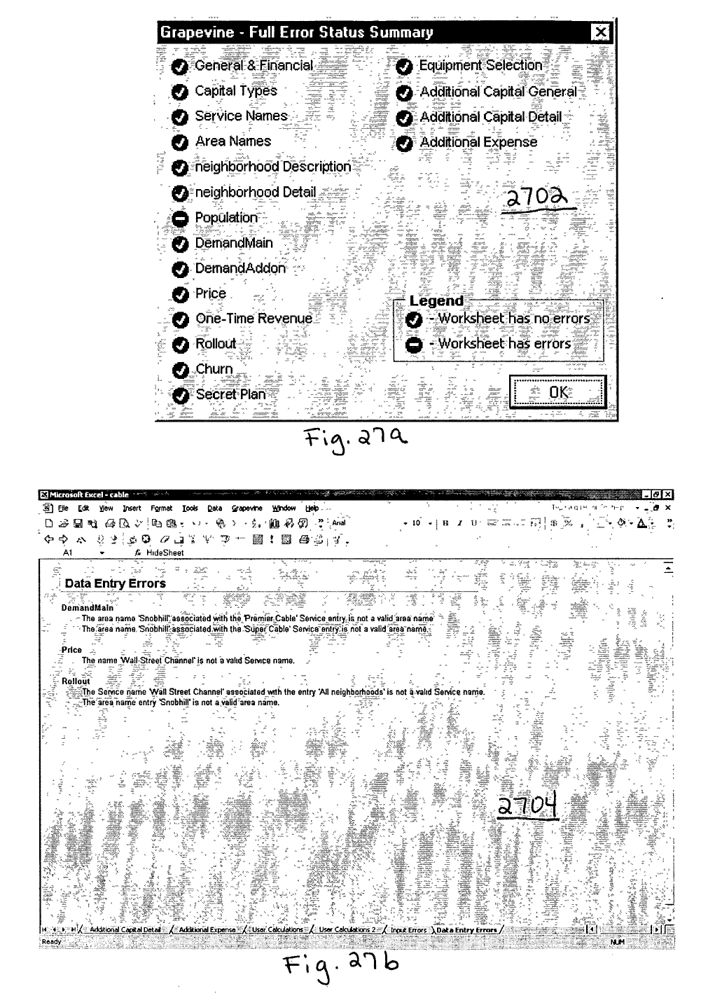

At any point during the data entry process, the model may by checked for errors regarding data entry. This may be accomplished as previously explained by selecting the page error check button 722 for each page individually. However, a second error checking button, the worksheet error button 2602 is provided to allow a review for errors throughout the workbook. When the worksheet error button 2602 is selected, this example of the present invention provides two useful summaries that identify different types of errors. FIG. 27a illustrates a worksheet error summary box 2702, which graphically identifies the error status of each data worksheet included in the workbook. FIG. 27b illustrates a workbook error summary box 2704 that identifies errors resulting from interactions among the pages of the workbook.

The foregoing description of the data entry operation describes only one example of the process by which data may be entered into the business case model. Many other embodiments of the present invention are possible that may enable or require different approaches to entering data, all within the scope of the present invention. Further, in any data entry operation, data may be entered by following a sequential process through the worksheets or other data entry tools, or data may be entered randomly, entering partial data on one or more worksheets and returning to enter the remaining data after entering data on other worksheets. However, it is apparent to those skilled in the art in light of the foregoing discussion that, depending on the specific embodiment of the present invention, it may be most efficient to enter data into certain of the worksheets before entering data into others, since the specific embodiment may include worksheets whose data entry fields are presented only in response to particular data being entered into other worksheets.

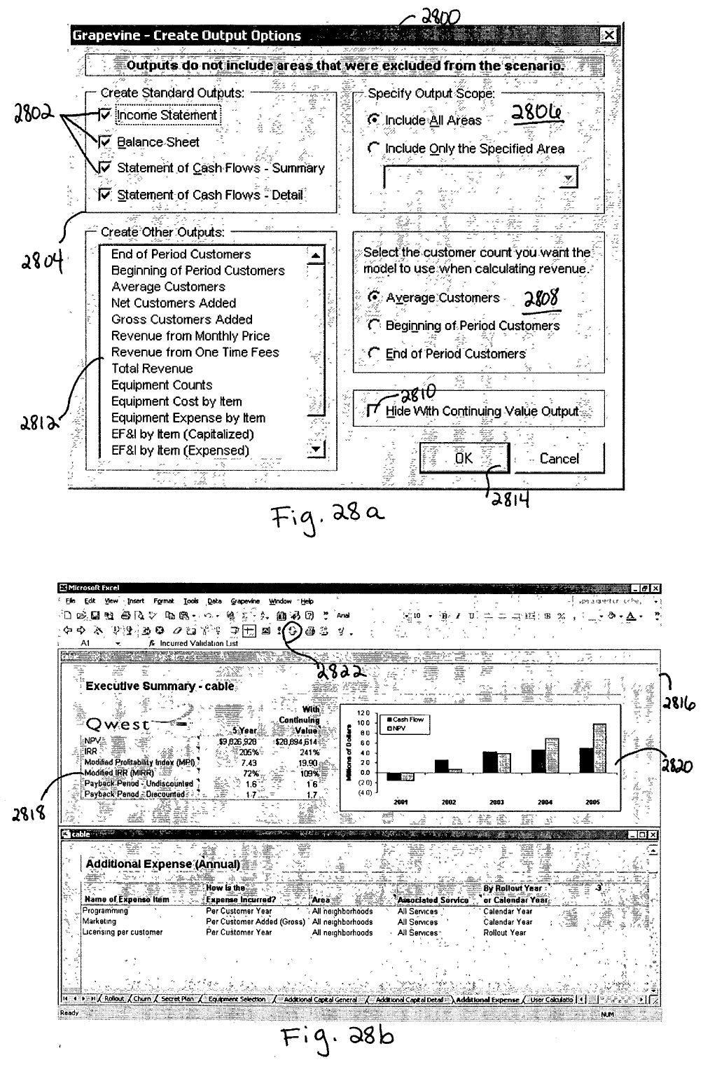

Once sufficient data is entered into the workbook, additional worksheets representing the output from the model may be generated automatically. The following example illustrates only one embodiment of the present invention. Many other possibilities exist, as will become apparent to those skilled in the art, all of which remain within the scope of the present invention. In this example of the present invention, the process to generate output is initiated by selecting the create output button 2604, identified in FIG. 26. In response, a dialogue box 2800, shown in FIG. 28a appears, which allows the form of the output to be customized. For example, in this embodiment of the present invention, standard output worksheets include an income statement, a balance sheet, a summary cash flow statement, and a detail cash flow statement. Each standard worksheet can be selected or not, depending on the election made using checkboxes 2802, in a create standard outputs window 2804 of the dialogue box 2800.

Another feature for selecting output includes electing which geographic areas to include in the analysis. It maybe desirable to include only certain geographic areas in a particular analysis. This feature makes selecting only certain geographic areas possible without resorting to deleting the data associated with the other areas. This selection is made in the “specify output scope” window 2806 of the dialogue box 2800.

Another feature of the output process includes determining how the customer base should be represented in the output. Because the number of customers may vary throughout the analysis, options are provided for selecting whether the analysis should be based on customers at the beginning of the year, at the end of the year, or on an average for the year for each year of the analysis. Other options are possible, although not listed in this example. The selection is made through the customer count window 2808 of the dialogue box 2800.

Another feature of the output of this example of the present invention is a “continuing value” calculation that determines the continuing value of certain of the financial parameters by assuming the cash flow in the last year of the analysis continues indefinitely. Because this assumption my be erroneous, an election may be made to hide the continuing value result in the output summary to avoid confusion or for other reasons. This election is made by checking the hide continuing value box 2810 in the dialogue box 2800.

Additional output worksheets may be possible, depending on the particular embodiment of the invention, the number and variety of which being largely dependent on the data requested by the model or provided by a user. The “other output” window 2812 lists a number of examples provide in this example of the present invention, any or all of which may be selected. Once the various output parameters are selected, the output may be generated by taking an appropriate action, in this case selecting an OK button 2814 of the dialogue box 2800.

The output is presented in a number of different ways and at several levels of detail. FIG. 28b illustrates the highest level of detail in an “executive summary” worksheet 2816. The executive summary worksheet 2816 includes a summary of the primary financial statistics for the project in a “financial statistics tabulation” window 2818. The tabulation includes: net present value; internal rate of return; modified profitability index; modified internal rate of return; and the discounted and undiscounted payback periods. Other embodiments of the present invention might include other financial statistics. The executive summary worksheet 2816 also include a graph 2820 for depicting the cash flow and net present value statistics. Again, other embodiments of the invention might provide different graphs.

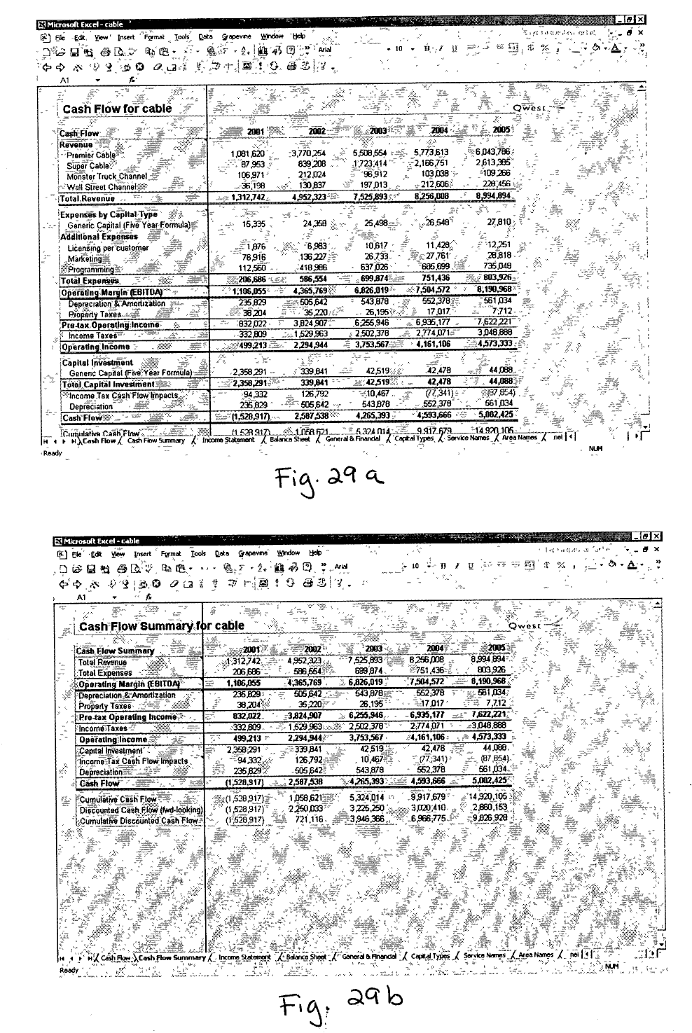

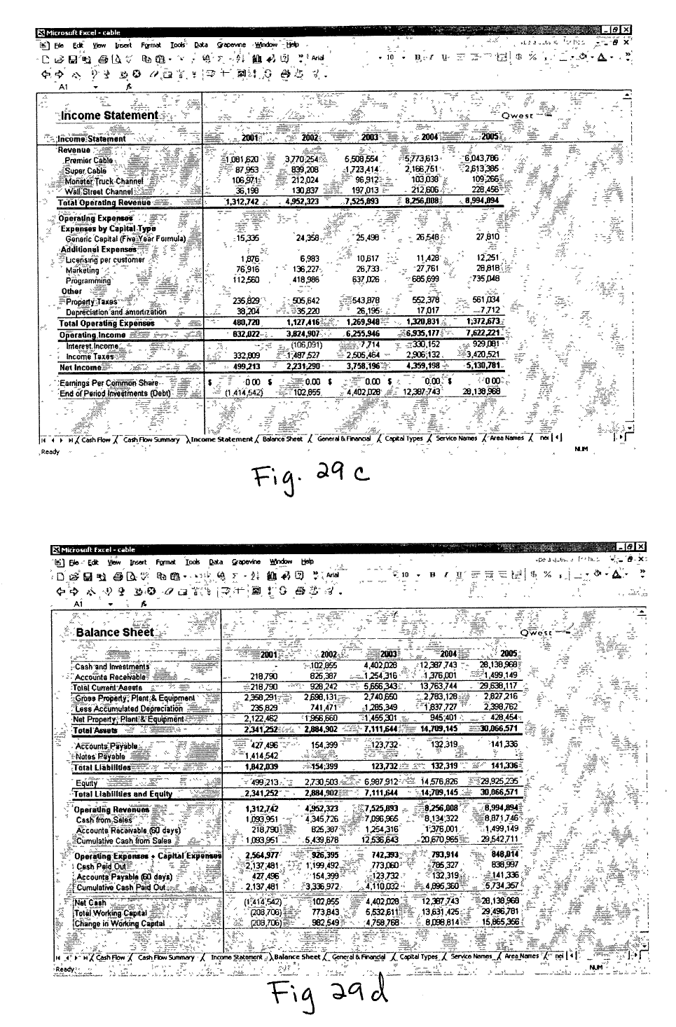

In addition to the executive summary worksheet 2816, a number of standard accounting statements are provided, including cash flow statements, an income statement and a balance sheet. These statements are well known to those skilled in the art. FIGS. 29a-29d illustrate several such statements. Others are possible.

Another output feature of this embodiment of the present invention includes a number of worksheets illustrating the preliminary calculations leading to the previously mentioned output worksheets. Though not shown, these preliminary calculation worksheets may be available through the output process.

The output worksheets may be presented in a number of ways. For example, the worksheets may be viewed on a monitor associated with a computer, or the worksheets may be printed. A number of different printing options are provided. Other means for viewing the output are also possible. For example, the output may be exported to another software program for further evaluation or for incorporation into a presentation.

An important feature of this example of the present invention is the cell iterator feature. The cell iterator feature provides the capability to evaluate a project using a range of values for an input variable. It executes the model using each value without requiring the user to enter a new value into the appropriate worksheet each time the model is executed. The result provides insight into the business case's sensitivity to the variable.

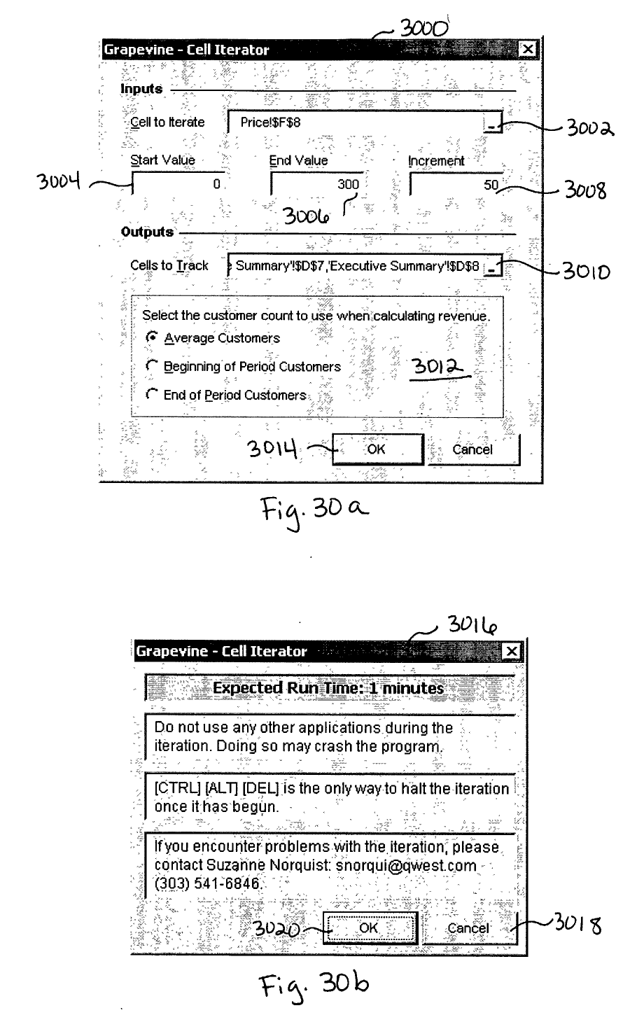

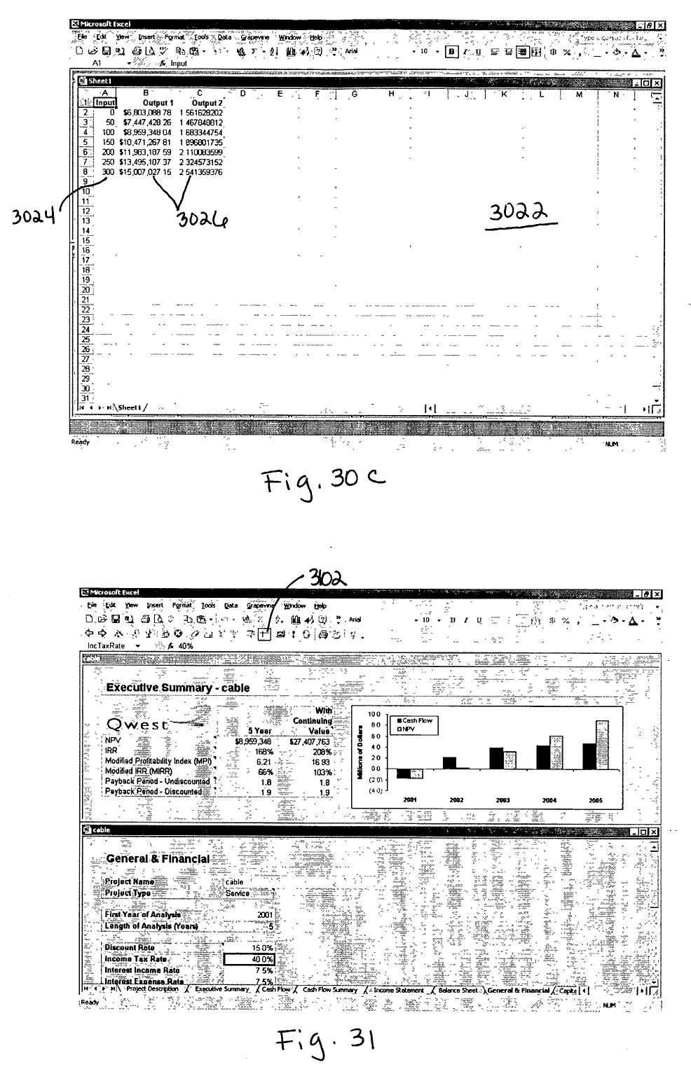

The cell iterator feature is accessed by selecting the cell iterator button 2822 identified in FIG. 28b. In response, a cell iterator dialogue box 3000, FIG. 30a, is displayed into which information is entered that defines the function. The dialogue box 3000 includes a “cell to iterate” field 3002, a “start value” field 3004, an “end value” field 3006, and an “increment” field 3008. The information entered into the cell to iterate field 3002 tells the model which input variable to change. The information identifies the worksheet containing the variable and the location of the variable on the worksheet. The information entered into the start value field 3004 and the end value field 3006 tell the model the staring value and the ending value, respectively, to use for the variable. The increment field 3008 tells the model by how much to increase or decrease the value for each execution of the model.

The cell iterator dialogue box 3000 also includes a “cells to track” field 3010 and a “customer count” window 3012. The information entered into the cells to track field 3010 tells the model which intermediate or output variable to record each time the model is executed. Multiple intermediate and/or output variables may be recorded. Thus, the user can specify the particular variables of interest and not require the model to record all the available output worksheets for each iteration through the range of the input variable. The customer count window functions similarly to the customer count window 2808 of FIG. 28a.

Once the appropriate information is entered into the cell iterator dialogue box, selecting the OK button 3014 initiates the function. In this example of the present invention, an informational dialogue box 3016, FIG. 30b, appears, providing an estimate of the run time and other cautionary information regarding the cell iterator function. The user can elect to end the function by selecting the cancel button 3018, or proceed with the analysis by selecting the OK button 3020.

The cell iterator feature produces a worksheet 3022, FIG. 30c, that includes a tabulation of the results of the function. An input column 3024 identifies the input variable used in each iteration of the model. The input variable is the variable identified in the cell to iterate field 3002 of the cell iterator dialogue box 3000 of FIG. 30a. The worksheet 3022 also includes an output column 3026 for each intermediate or output variable identified in the cells to track field 3010 of the cell iterator dialogue box 3000 of FIG. 30a. Each entry in the rows of each output column 3026 corresponds with an input variable in the input column 3024. The presentation of the output of the cell iterator feature as illustrated in FIG. 30c allows for convenient access to the data for other spreadsheet functions such as graphing. Further, the output data may be easily exported to other software programs for further processing or incorporation into presentations.

Another powerful tool provided by this example of the present invention is the Monte Carlo simulation feature. Monte Carlo simulation is well known in the art. However, the present invention provides the capability to incorporate a Monte Carlo simulation into the business case model and display the results as part of the executive summary. The present invention also provides a wizard for configuring the Monte Carlo simulation.

In brief, a Monte Carlo simulation processes one or more input variables, each having a specified probability distribution, using a defined function. The simulation continues for a defined number of trials, during each of which trials the function operates on a random sampling of the variables based on the probability distribution of each variable. The output from the series of trials may be viewed using a number of useful graphical tools that illustrate the most probable results and the variables that most influenced the results.

In the case of the present invention, the input variables may be variables from the various data worksheets previously discussed, while the function is the business case model which operates upon the variables. The number of trials may be specified. The output in the present example includes a histogram of two key financial statistics, net present value and internal rate of return, and a “tornado diagram” illustrating the correlation coefficient between each input variable and the results of the simulation. Other output variables may be observed, and other forms of output may be used to illustrate the results. The example herein is representative, and other possibilities will be apparent to those skilled in the art.

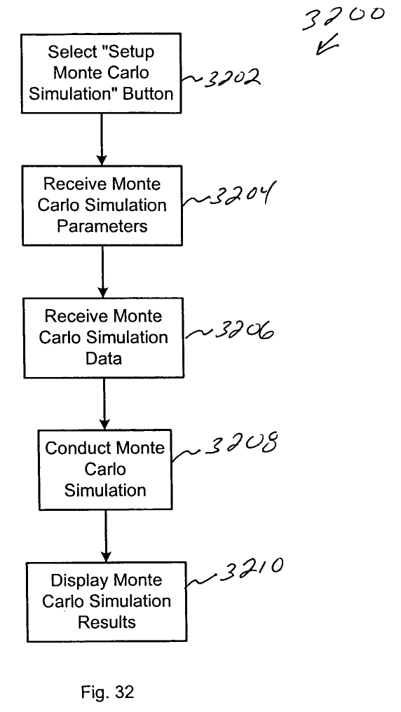

FIG. 32 illustrates a method of performing a Monte Carlo simulation according to one embodiment of the present invention. The system for performing the Monte Carlo simulation may be identical to the system for evaluating business cases as previously discussed with reference to FIG. 1. The operation begins when the “setup Monte Carlo” button 3102, FIG. 31, is selected at step 3202. At step 3204, information representing the parameters of the Monte Carlo simulation are received by a computing device, such as the computing device 102 of FIG. 1, upon which the simulation takes place. The parameters may include for example, a listing of the input variables to be used in the simulation. At step 3206, the Monte Carlo simulation data are received by the computing device. The Monte Carlo simulation data may include the number of trials to be performed in the simulation, and the probability distribution of each variable to be included in the simulation. At step 3208, the simulation is carried out for the business case model using the parameters identified in step 3204 and the data received in step 3206. At step 3210, the results of the simulation are displayed.

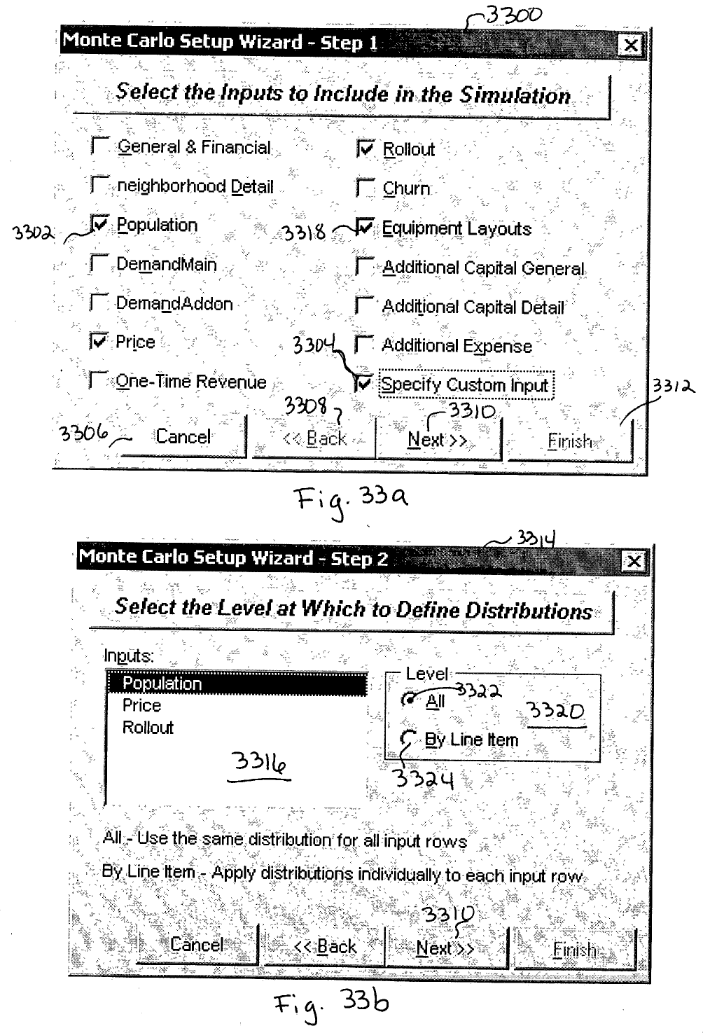

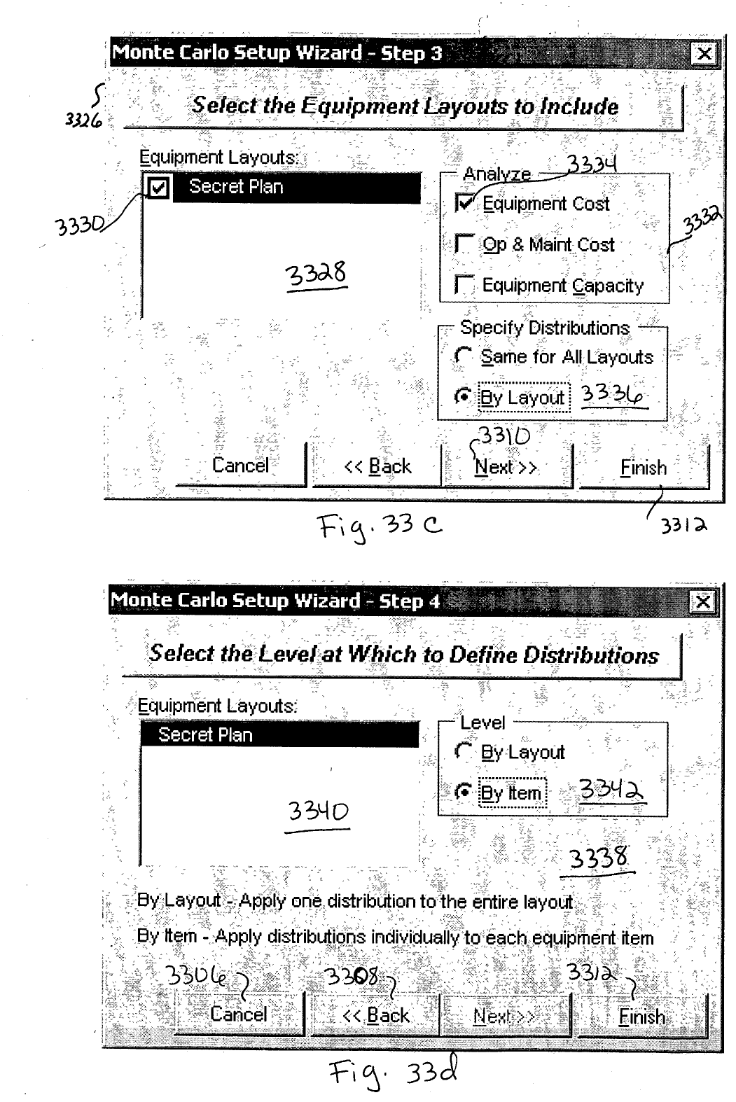

Having discussed the Monte Carlo simulation feature broadly, the feature will now be presented in greater detail according to one embodiment of the present invention through the use of an example. The Monte Carlo simulation feature of the present invention is initiated by selecting the setup Monte Carlo button 3102 of FIG. 31 as previously mentioned. Selecting the button causes the first dialogue box of a wizard to be presented. As with other familiar wizards, the series of dialogue boxes comprised by the wizard include a number of fields for entering relevant information. In this example, the relevant information includes the parameters of the Monte Carlo simulation. The first dialogue box, the step 1 dialogue box 3300, is shown in FIG. 33a. The step 1 dialogue box 3300 contains a listing that includes the worksheets from the business case model. Next to each worksheet in the list is a checkbox, for example a population worksheet checkbox 3302, to select whether data from the worksheet will be included as one of the variables in the Monte Carlo simulation. Additionally, the step 1 dialogue box 3300 includes a “specify custom input” checkbox 3304 for indicating whether additional input variables are desired. The step 1 dialogue box 3300 includes other familiar wizard features such as, for example, the cancel button 3306, the back button 3308 (dimmed in the step 1 dialogue box 3300, since the step 1 dialogue box is the first in the series), the next button 3310, and the finish button 3312 (also dimmed in the step 1 dialogue box 3300). Once the appropriate information is entered into the step 1 dialogue box 3300, the next button 3310 is selected.

Selecting the next button 3310 of the step 1 dialogue box 3300 causes the step 2 dialogue box 3314 to be presented. The step 2 dialogue box 3314, illustrated in FIG. 33b includes fields for indicating the level at which input variable distributions will be defined for certain of the variables. The step 2 dialogue box includes a list 3316 of certain of the worksheets selected in the step 1 dialogue box 3300. The list is not necessarily a complete list. For example, if the “equipment layouts” worksheet checkbox 3318 in the step 1 dialogue box 3300 was selected, “equipment layouts” does not appear in the list 3316. Monte Carlo simulation variables from the equipment layout worksheets will be configured in other wizard steps as described hereinafter. For each of the worksheets listed, a selection is made by highlighting the item and selecting a radio button in the “level” field 3320, indicating whether the same distribution is used for all variables in the selected worksheet (by selecting the “all” radio button 3322) or whether different variables may have different distributions (by selecting the “by line item” radio button 3324). Once a selection is made for each listed worksheet, the next button 3310 of the step 2 dialogue box is selected to advance to the step 3 dialogue box 3326.

The step 3 dialogue box 3326, illustrated in FIG. 33c, provides for specifying the level at which input variable distributions will be defined for Monte Carlo simulation input variables from the equipment layout sheet or sheets. It also provides for specifying which variables to include in the simulation. For example, variables from the fixed cost, variable cost and capacity sections of the equipment layout sheets may be selectively included. The step 3 dialogue box 3326 includes a list 3328 of the equipment layout worksheets from the model. In this example, only one equipment layout worksheet is listed because only one was configured into the business case model. Each item in the list includes a checkbox 3330 for indicating whether the worksheet should be included in the simulation. The step 3 dialogue box 3326 also includes an “analyze” window 3332 having a list of the sections of each equipment layout worksheet. Each listed item has a checkbox, such as the equipment cost checkbox 3334, for selecting whether variables from the section should be included in the Monte Carlo simulation. Thus, for each worksheet checked in the list 3328, an independent selection is made in the analyze window 3332 for each listed section. An additional selection is made for each selected equipment layout worksheet whether to specify the probability distribution by worksheet or to use the same distribution for all equipment layout worksheets. This selection is made in the “specify distributions” window 3336. Once the appropriated information is entered into the step 3 dialogue box 3326, the next button 3310 or the finish button 3312 is selected.

Selecting the next button 3310 of the step 3 dialogue box 3326 causes the step 4 dialogue box 3338 to be presented. The step 3 dialogue box 3338, illustrated in FIG. 33d, includes a list 3340 of the equipment layout worksheets selected in the step 3 dialogue box 3326. For each such listed equipment layout worksheet, a selection is made whether to specify the probability distribution for the entire worksheet or for each variable of the worksheet individually. The selection is made in the “level” window 3342. Once the appropriate information is entered into the step 4 dialogue box 3338, the finish button 3312 may be selected to conclude the wizard and configure the Monte Carlo simulation based on the parameters provided therein. Alternatively, the back button 3308 may be selected to modify information entered in previous steps, or the cancel button 3306 may be selected to terminate the Monte Carlo simulation.

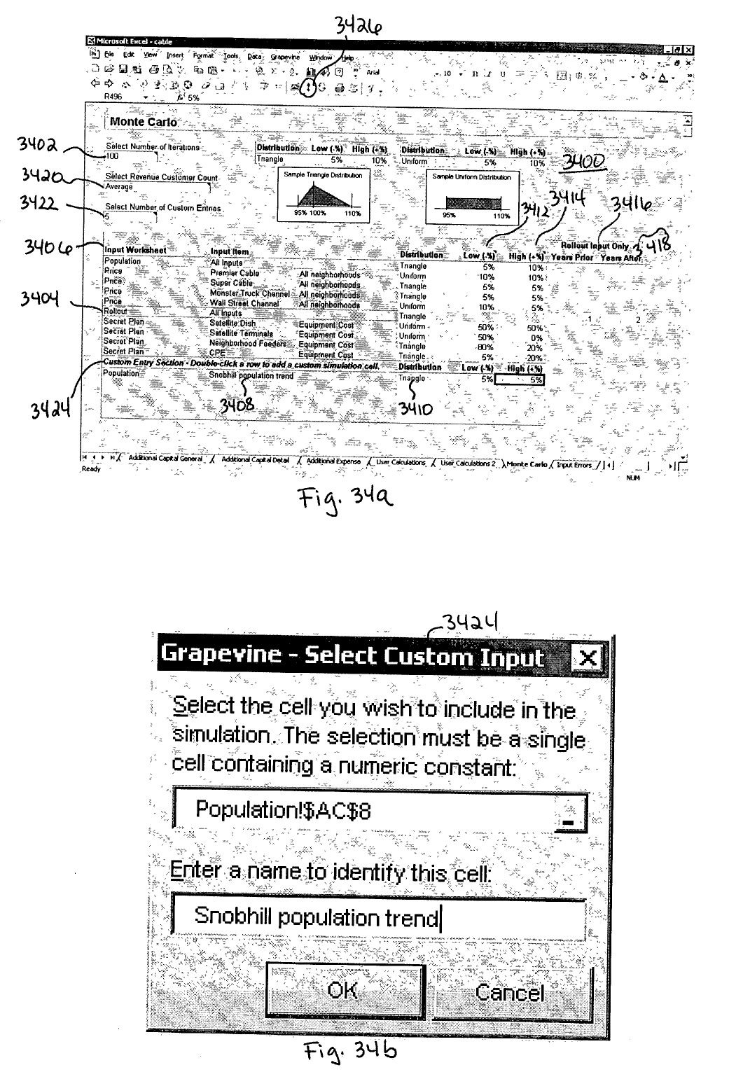

In this example of the present invention, completion of the Monte Carlo setup wizard causes a Monte Carlo data worksheet 3400 (FIG. 34) to be presented as part of the workbook. The worksheet 3400 includes an iteration field 3402 for selecting the number of trials the Monte Carlo simulation will perform using the business case model. Embodiments of the invention may include limitations on the minimum and/or maximum number of iterations that may be specified. A minimum number of iterations might be important for ensuring that the simulation produces statistically reliable results. A maximum number of iterations might be important for ensuring that the simulation is accomplished within a reasonable period of time given the speed and power of the computing device.

The Monte Carlo data worksheet 3400 also includes a data window 3404, wherein the probability distribution for each Monte Carlo simulation variable is specified. The window 3404 includes a worksheet list 3406 of the data worksheets from which the variables may come. The worksheet list 3406 is generated, in part, from the information provided during the Monte Carlo simulation wizard. The window 3404 also includes a variable list 3408 for identifying which variables from the listed worksheets correspond to the probability distribution in the distribution column 3410. The distribution column 3410 is for specifying the probability distribution for each Monte Carlo simulation variable. In this example of the present invention, the specified probability distribution may be uniform or triangular. However, other probability distributions are possible, including for example, normal and lognormal. Additionally, embodiments of the present invention may include means for basing the probability distribution on a real data set associated with a variable. The real data may be included in one or more databases, such as database 104 of FIG. 1. No distribution may be specified in this example by entering “none” in the distribution column 3410, in which case, the variable takes the value specified in its associated data sheet during the Monte Carlo simulation.

Four additional data columns are provided for more particularly specifying the probability distribution for each listed variable. These include a “low” column 3412, a “high” column 3414, a “years prior” column 3416 and a “years after” column 3418. The high and low columns are for specifying the upper and lower bounds, respectively, for a given variable. In this example the entries for each variable are entered as a percentage. The percentage is the degree of variation from the value of the variable entered in the data worksheet associated with the variable in the business case model. In the case of triangular probability distributions, the value for the variable in its associated data worksheet is the most likely value. In the case of uniform distribution, all values between the low percentage of the value and the high percentage of the value are equally likely. The years prior and years after columns are for entering the lower and upper bounds, respectively, for variables in terms of years. Otherwise, the information operates similarly to the information entered into the high and low columns.

The Monte Carlo data worksheet 3400 includes two additional fields for configuring the Monte Carlo simulation. A “customer count” field 3420 determines how the customer population will be considered in the model, much like the customer count window 2808 of FIG. 28. The Monte Carlo data worksheet 3400 also includes a custom entries field 3422 for selecting the number of additional variables to include in the simulation. This field allows for entering variables from a data worksheet without having to go through the configuration process for the entire worksheet. Custom variables are entered into a custom variable window 3424 of the Monte Carlo data worksheet 3400. Individual variables are selected in this example by double clicking on a blank area in the custom variable window 3424 of the worksheet list 3406, which causes a custom input dialogue box 3424, FIG. 34b, to be presented. The custom input dialogue box 3424 includes fields for specifying the custom variable to be included in the simulation. The distribution information associated with each custom variable works similarly to the distribution information for the other Monte Carlo simulation variables. Once the appropriate information is entered to run the Monte Carlo simulation, a “run Monte Carlo simulation” button 3426 is provided to initiate the operation.

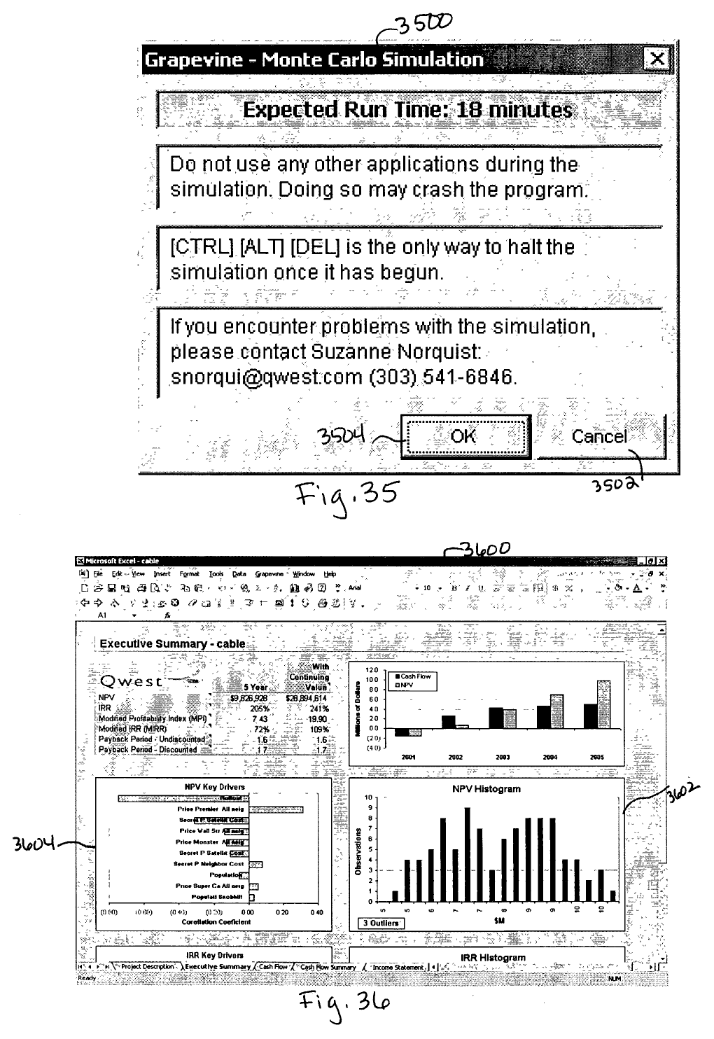

Selecting the run Monte Carlo simulation button 3426 causes an informational dialogue box 3500, illustrated in FIG. 35, to be presented. The informational dialogue box includes an estimate of the amount of time to complete the simulation and contains cautionary information regarding the Monte Carlo function. A user can elect to end the function by selecting the cancel button 3502 or proceed with the analysis by selecting the OK button 3504.

Once the Monte Carlo simulation is complete, a new executive summary worksheet 3600 is generated, as shown in FIG. 36. In addition to the information discussed previously, the new executive summary worksheet includes graphical illustrations of the Monte Carlo results. In this example of the present invention, the new executive summary includes a “net present value” histogram 3602 and a “net present value” tornado diagram 3604. This example of the present invention also includes an “internal rate of return” histogram and an “internal rate of return” tornado diagram, neither of which are fully visible in the new executive summary worksheet 3600; however, those skilled in the art will recognize that the internal rate of return graphs appear in a lower portion of the worksheet 3600.

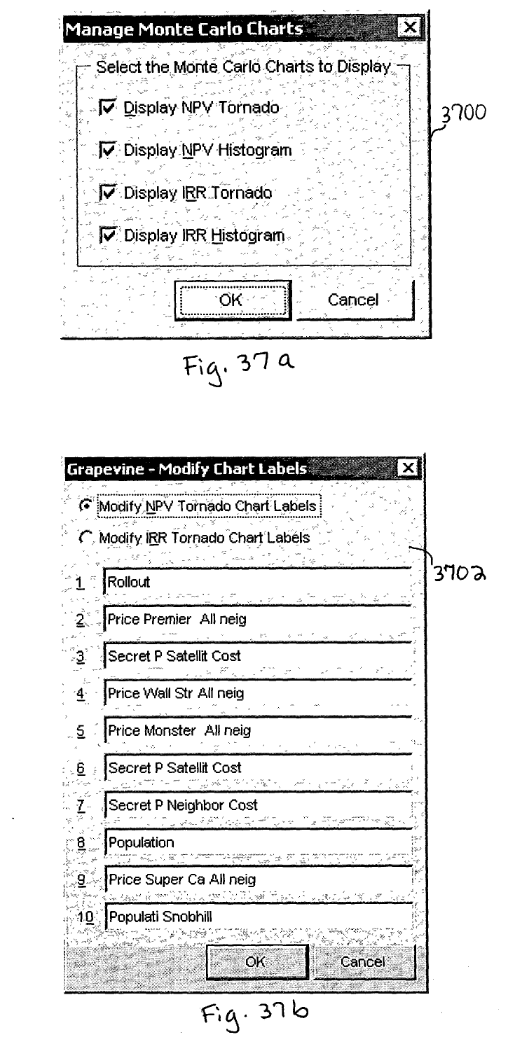

The appearance of the Monte Carlo simulation results in the new executive summary worksheet 3600 may be customizable. In the present example, the graphs may be customized by selecting either of two menu command that each cause a dialogue box to be presented. A “manage Monte Carlo charts” dialogue box 3700, FIG. 37, appears in response to a first menu selection. The manage Monte Carlo charts dialogue box 3700 allows for the selection of which Monte Carlo graphs to include in the new executive summary worksheet 3600. The second menu selection causes a “modify chart labels” dialogue box 3702, through which the labels for the variables listed in either of the tornado diagrams may be customized.

In conclusion, the present invention provides a novel method and system for evaluating business cases. While a detailed description of several embodiments of the invention has been presented, various alternatives, modifications and equivalents will be apparent to those skilled in the art, many of which do not vary from the spirit of the invention. Therefore, the above description should not be taken as limiting the scope of the invention, which is defined by the appended claims.

What is claimed is:

1. A method for evaluating a business case, comprising:
receiving configuration information relating to the business case into a computing device, thereby configuring the computing device to display one or more data entry screens tailored, based on the information, to the business case;
receiving data relating to the business case into the computing device via the one or more data entry screens;
processing the data to produce a first outcome from the model based on the data; and
displaying the first outcome.

2. The method as recited in claim 1, further comprising:
receiving different data relating to the business case into the computing device via the one or more data entry screens;
processing the data to produce a second outcome from the model based on the data; and
displaying the second outcome to a user.

3. The method as recited in claim 1, further comprising:
receiving information indicating one or more of the datum to be variable and defining the possible values for the one or more variable datum;
processing the data, including the possible values for the one or more variable datum, to produce a plurality of outcomes from the model based on the data; and
displaying the plurality of outcomes to a user.

4. A method as recited in claim 1, wherein the outcome includes a financial statement selected from a group consisting of income statement, balance sheet and cash flow statement.

5. The method as recited in claim 3, further comprising performing a Monte Carlo simulation of the model using one or more of the variable data.

6. The method as recited in claim 5, further comprising displaying a histogram of the different outcomes from the Monte Carlo simulation.

7. The method as recited in claim 3, wherein the information defining the possible values for the one or more variable datum includes a lowest value, a highest value and an increment for each value between the lowest value and the highest value for each of the one or more variable datum, the method further comprising producing an outcome from the model for each of the possible values for the one or more variable datum.

8. The method as recited in claim 1, further comprising:
configuring, based on the information relating to the business case, at least one of the one or more data entry screens to detect occurrences of particular information and upon detecting the information, produce an alert indicating the occurrence of the information.

9. The method as recited in claim 8, wherein the occurrence of particular information constitutes an error.

10. The method as recited in claim 1, further comprising receiving information relating to one or more geographic regions throughout which the business case could be implemented.

11. The method as recited in claim 10, further comprising receiving information relating to the expected demand relating to the business case in each geographic region based on the population in each of the one or more geographic regions.

12. The method as recited in claim 10, further comprising receiving pricing data for each of the one or more geographic regions throughout which the business case could be implemented.

13. The method as recited in claim 12, wherein the pricing data is different for at least two of the one or more geographic regions.

14. The method as recited in claim 1, further comprising receiving information relating to the expected demand for each of one or more geographic regions throughout which the business case could be implemented.

15. The method as recited in claim 1, further comprising receiving information relating to the capital equipment to implement the business case.

16. The method as recited in claim 15, further comprising receiving information relating to the depreciation method to be used for the capital equipment.

17. The method as recited in claim 1, wherein the business case relates to a product.

18. The method as recited in claim 1, wherein the business case relates to a service.

19. A computer system for evaluating a business case, comprising:
a storage device;
an input device;
a display device;
a processor; and
a communications device configured to exchange data among the storage device, the input device, the display device, and the processor;
wherein the processor is configured to:
present model configure data screens on the display device;
present business case data screens on the display device based on model configuration data;
calculate the outcome for the business case based on the model configuration data and the business case data;
present a summary of the outcome for the business case on the display device; and
store the model configuration data and the business case data on the storage device.

20. The computer system as recited in claim 19, wherein the business case model is developed using a spread sheet.

21. The computer system as recited in claim 20, wherein the spread sheet includes a workbook having one or more worksheets.
